(19) United States
(12) Patent Application Publication
(10) Pub. No.: US 2026/0105609 A1
(43) Pub. Date: Apr. 16, 2026

(54) TECHNIQUES FOR PARTITIONING IMAGES FOR MACHINE LEARNING MODELS

(71) Applicant: Oracle International Corporation, Redwood Shores, CA (US)

(72) Inventors: Reetesh Mukul, Bangalore (IN); Kulbhushan Pachauri, Bangalore (IN)

(73) Assignee: Oracle International Corporation, Redwood Shores, CA (US)

(21) Appl. No.: 18/915,269

(22) Filed: Oct. 14, 2024

(51) Int. Cl. G06T 7/11; G06T 3/20; G06T 3/4038; G06T 7/00

(52) U.S. Cl. CPC G06T 7/11; G06T 3/20; G06T 3/4038; G06T 7/0002; G06T 2207/20021; G06T 2207/20084; G06T 2207/20221; G06T 2207/30242

(57) ABSTRACT

A memorability prediction system (MPS) is described for predicting image memorability of an input image while considering the contribution of sub-images and pixels of the input image. In some embodiments, the input image may be partitioned (also referred to as diced) randomly into multiple sub-images. Various techniques for dicing the input images are described. In certain embodiments, the input image may be partitioned randomly into one or more segments in both the x-dimension (e.g., width) and the y-dimension (e.g., height). The segments in both dimensions may be combined to generate sub-images in different sizes. In some embodiments, objects in the input image may be identified, and the sub-images may be re-arranged or re-oriented according to an arrangement configuration to achieve higher probability of partitioning or preserving one or more objects. In some embodiments, a pre-defined partition may be used for one or more regions of the input image.

### CROSS-REFERENCES TO RELATED APPLICATIONS

This application is related to U.S. Non-Provisional application Ser. No. 18/915,235, filed Oct. 14, 2024, entitled “TECHNIQUES FOR PREDICTING IMAGE MEMORABILITY,” the disclosure of which is incorporated by reference in its entirety for all purposes.

### FIELD

The present disclosure generally relates to the partitioning images for use by machine learning (ML) models. More specifically, techniques are described for partitioning images (also referred to as dicing) to help identify the contributions of various parts of an input image to the memorability score of the input image.

### BACKGROUND

Image memorability has a lot of applications, such as education for creating more effective visual aids, user-interface design, public health, and advertisement.

### BRIEF SUMMARY

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

In some embodiments, a method includes receiving, by a computing system, a two-dimensional image comprising a first dimension, a second dimension, and one or more objects; receiving, by the computing system, a range threshold for each sub-image, the range threshold comprising a lower boundary and an upper boundary of number of pixels; partitioning, by the computing system, the first dimension of the image into a set of first-dimension (D1) segments, the length of each of the set of D1 segments being a different D1 random number and within the range threshold; partitioning, by the computing system, the second dimension of the two-dimensional image into a set of second-dimension (D2) segments, the length of each of the set of D2 segments being a different D2 random number and within the range threshold; creating, by the computing system, a set of sub-images from the images by combining the set of D1 segments and the set of D2 segments in one-to-one correspondence; and re-arranging, by the computing system, the set of sub-images randomly in both the first dimension and the second dimension.

In some embodiments, partitioning the two-dimensional image further comprises: setting a first segment of the set of D1 segments to be a first particular D1 length; partitioning the first dimension using the remaining D1 segments, wherein each of the remaining D1 segments has a different D1 random number; setting a second segment of the set of D2 segments to be a second particular D2 length; and partitioning the second dimension using the remaining D2 segments, wherein each of the remaining D2 segments has a different D2 random number.

In some embodiments, the method further includes: creating a first sub-image having a width of the first particular D1 length and a height of the second particular D2 length, wherein the first sub-image overlaps at least a first object of the one or more objects in the two-dimensional image.

In some embodiments, the method further includes: merging two or more adjacent sub-images into a larger sub-image, wherein the larger sub-image has width and height each within the range threshold.

In some embodiments, re-arranging the set of sub-images further comprises: determining the number of objects in the one or more objects in the two-dimensional image; dividing the two-dimensional image into one or more regions; identifying at least a first region that includes a greater number of objects than other regions; and moving sub-images of the set of sub-images based at least in part on an arrangement configuration.

In some embodiments, the arrangement configuration is a higher probability of partitioning more objects, and moving sub-images of the set of sub-images comprises moving smaller sub-images of the set of sub-images closer to the first region

In some embodiments, the arrangement configuration is a higher probability of having one sub-image covering more objects, and moving sub-images of the set of sub-images comprises moving larger sub-images of the set of sub-images closer to the first region.

In some embodiments, the method further includes: editing a sub-image of the set of sub-image to change one or more characteristics of the two-dimensional image.

In some embodiments, the one or more characteristics of the two-dimensional image comprise memorability of the two-dimensional image.

In various embodiments, a system is provided that includes one or more data processors and a non-transitory computer readable medium containing instructions which, when executed on the one or more data processors, cause the one or more data processors to perform part or all of one or more methods disclosed herein.

In various embodiments, a non-transitory computer-readable medium, storing computer-executable instructions which, when executed by one or more processors, cause the one or more processors of a computer system to perform one or more methods disclosed herein.

In various embodiments, a computer-program product, comprising computer program/instructions which, when executed by a processor, cause the processor to perform any of the methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment 100 illustrating an architecture of a trained memory interaction map network (MIMNet), according to certain embodiments.

FIGS. 2A-2B are example diagrams of image dicing techniques, according to certain embodiments.

FIGS. 3A-3B are example diagrams of image dicing techniques, according to certain embodiments.

FIG. 4 is a simplified block diagram illustrating an attention map layer (A_{M}) in a vision transformer for the MIMNet architecture, according to certain embodiments.

FIG. 5 is an example flowchart illustrating processing performed by a MIMNet, according to certain embodiments.

FIG. 6 is an example flowchart illustrating a method of image dicing, according to certain embodiments.

FIG. 7 is an example flowchart illustrating a method for memorability interaction (called attention pass) used in a MIMNet, according to certain embodiments.

FIG. 8 is a simplified block diagram of a training environment 800 that may be used to train a memory interaction map network (MIMNet), according to certain embodiments.

FIG. 9 is an example flowchart illustrating a method for training a memory interaction map network (MIMNet), according to certain embodiments.

FIG. 10 is a block diagram illustrating one pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating an example computer system, according to at least one embodiment.

### DETAILED DESCRIPTION

Memorability is a stable property (or metric) of an image that is shared across different viewers. A memorability score may quantify how likely an image is to be remembered by viewers. Such scores may be derived from visual recognition memory tasks where subjects view a series of images and later identify whether they have seen them before. Image memorability scores can be computed as the subject average performance at remembering a particular image (the hit rate, HR), corrected for the rate of calling novel images familiar (the false alarm rate, FAR). The memorability scores may be normalized to values in the range between 0 and 1, and be treated as a regression value or a probability.

Machine learning (ML) models may help predict memorability (or referred to herein as memorability score). A Spearman correlation coefficient (or Spearman rank correlation) may serve as a metric in evaluating the performance of image memorability prediction models. In reality, the memorability of an image may depend on its constituent components. Some techniques may concentrate on a global memorability score. Yet, certain models (e.g., convolutional neural network (CNN)) may not be able to capture interaction among image pixels, resulting in using one scalar value, memorability score, for training. Because many models do not take into account the various constituent components, such as sub-images, individual objects, and pixels within an image, their Spearman rank correlation scores are not satisfactory. Thus, there is a need to address these challenges and others.

### I. Memorability Detection System

The disclosed techniques describe a memorability prediction system (MPS) for predicting image memorability of an input image by considering the contribution (e.g., memorability effect, weights, or importance, etc.) of various sub-images and pixels within an input image (also called a main image or an overall image that has not been processed or partitioned), and interaction (e.g., semantic or memorable connotations) among sub-images and the dimensionality aspect (e.g., area ratio). For example, an image may contain several objects, some are live objects (e.g., animals), artistic (e.g., portraits and architectural designs), or other different types. Each object may play a different role or have various degrees of contribution to the overall memorability of the whole image because a viewer may have different memorability toward different objects due to their natures and how they are presented in the main image.

The MPS includes a visual transformer-based memorability prediction network, referred to herein as memory interaction map network (MIMNet), containing three models that are integrated to perform image memorability detection. The first model may be a vision transformer (ViT, referred to as M-core) responsible for processing the main image (or input image). The second model may be another vision transformer (referred to as M-helper) responsible for processing diced images. The third model may be a convolution model (e.g., residual network (ResNet)) responsible for processing individual pixels of the input image. A mechanism, called attention passage, identifying the relationship (e.g., differences in their estimated memorability strength/scores) between a sub-image and the main image, can pass such memorability-related information (in the form of pre-attention, e.g., queries and vectors) between the two ViTs (i.e., the M-core and M-helper) to determine how a sub-image contribute to or affect the memorability score of the input image (or main image).

For the purpose of this disclosure, an input image to MPS may also be referred to as a main image or an overall image to denote the image that is not partitioned (or diced). An input image may be processed (e.g., through image preparation) before providing to different models in the MIMNet. In some embodiments, the main image is the same as the original input image, or is not partitioned (or diced). Such a main image may contain one or more objects. Thus, input image and main image may be used interchangeably.

In some embodiments, a dicing mechanism as part of image preparation is introduced to generate a stack of randomly diced and resized images. The dicing mechanism can randomly partition the input image (or main image) into a number of sub-images (referred to herein as diced images) that may not be equal in size (e.g., height×width). Each diced image may have a width and height within a specific range. Such diced images help identify the contributions of various parts of the main image to the memorability score of the main image.

For the purpose of this disclosure, a sub-image refers to a partition of a main image after dicing. A sub-image as a result of dicing may be referred to as a diced image (also referred to as a cropped image from dicing). Thus, sub-image, diced image, and cropped image may be used interchangeably in the context of dicing.

In some embodiments, the diced images (or sub-images) may be re-arranged or re-oriented randomly in the main image to further capture different parts (e.g., objects) of the main image, achieving a higher probability of dicing (or partitioning) more objects or a higher probability of having one diced/sub-image image covering more objects. In other embodiments, a combination of pre-defined partitions and random partitions may be used in different regions of a main image.

The disclosed techniques introduce standalone memorability and relative memorability. A standalone memorability may refer to the memorability of an image, whether the image is a main image or a sub-image. A relative memorability may indicate the memorability contribution (e.g., relative weight) of a sub-image (e.g., after dicing) toward the main image because a sub-image may have more or less memorability than the main image. The role (or contribution) played by a sub-image may depend on the relative dimension (or area ratio) of the sub-image in the main image. In certain embodiments, a memorability map per pixel may be generated to indicate the memorability of a small region (e.g., a patch of 8×8 pixels) or even an individual pixel within the main image, such as a visual map highlighting which pixels or regions are most likely to be retained in human memory.

In some embodiments, one or more sub-images may be edited to improve the memorability of the main image. For example, a particular sub-image may be identified to have a lower relative memorability than other sub-images, the particular sub-image may be edited in a way (e.g., change the size of an object captured in that sub-image) to enhance the overall memorability.

In some embodiments, a training technique is used for training MIMNet in the MPS. A training dataset used for the training includes multiple training datapoints, where each training datapoint includes an input image and associated annotation information that includes a target memorability score. Three types of losses, core prediction loss (from M-core), relative memorability prediction loss (from M-helper), and memorability map loss (from ResNet), may be calculated. An aggregated training loss may be computed for the MIMNet. Loss minimization techniques are used for minimizing the aggregated loss computed for the entire MSP.

Embodiments of the present disclosure provide several advantages/benefits. For example, three different types of memorability (standalone memorability, relative memorability, and memorability map per pixel) can enable the MPS to identify the memorability contributions of different parts of an input image (or main image), instead of rigidly treating the input image as a whole. Additionally, randomly, or purposefully dicing an image with or without considering its underlying objects can help explore different parts and various aspects of the image. Finally, with the above techniques about different types of memorability and dicing, the MPS can identify the memorability strengths and weaknesses of sub-images and then can improve the memorability of the main image by editing certain sub-images.

### A. Architecture

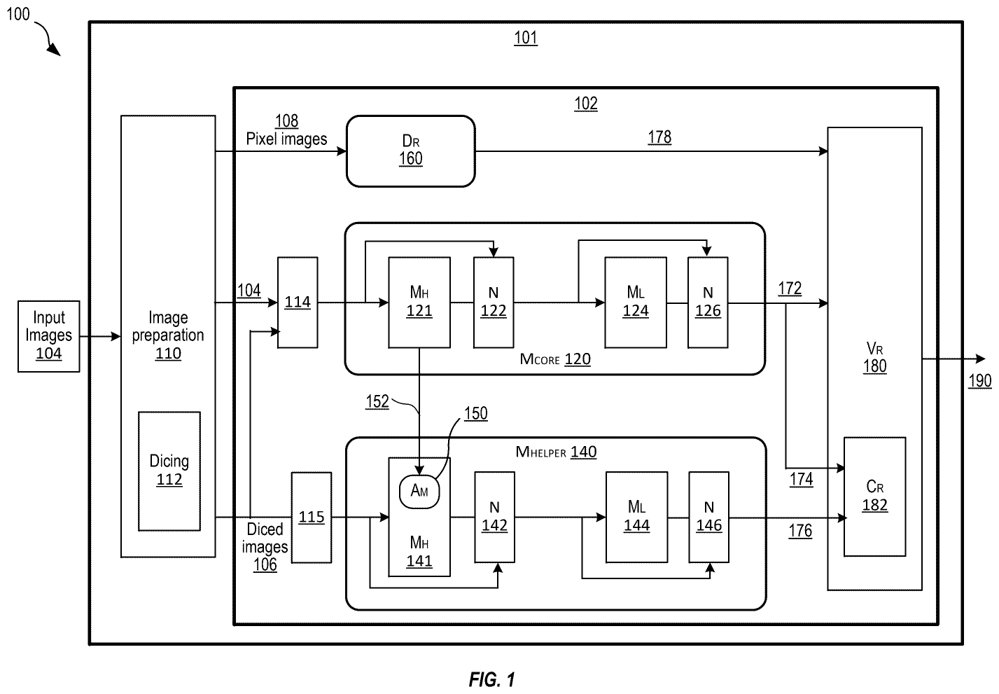

FIG. 1 is a simplified block diagram of a distributed environment 100 illustrating an architecture of a trained memory interaction map network (MIMNet), according to certain embodiments. Distributed environment 100 depicted in FIG. 1 is merely an example and is not intended to unduly limit the scope of claimed embodiments. Many variations, alternatives, and modifications are possible. For example, in some implementations, distributed environment 100 may have more or fewer systems or components than those shown in FIG. 1, may combine two or more systems, or may have a different configuration or arrangement of systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

The memorability prediction system (MPS) depicted in FIG. 1 may be implemented in different ways. In certain implementations, one or more computer systems may be used to implement the MPS. In some implementations, the functionality provided by the MPS may be offered as a cloud service by a cloud services provider (CSP). The cloud service may be made available to customers of the CSP that subscribe to the service. In such a cloud-based embodiment, the MPS may be implemented using infrastructure (e.g., compute, memory, and networking infrastructure) provided by the CSP.

As shown in FIG. 1, a MPS 101 may include a trained MIMNet 102, an image preparation module 110, and input images 104. The MPS may be capable of generating predicted memorability 190 at run time based on input images 104. The MIMNet 102 may further include three models: a first ViT (M-core) 120, a second VIT (M-helper) 140, a dilated Resnet (D_{R}) 160, and a regression feature unit (VR) 180 for processing the output of these models.

In some embodiments, the M-core 120 and D_{R} 160 may be sufficient for run-time inference to predict memorability score of an input image at pixel level. In other embodiments, all three models M-core 120, M-helper 140, and D_{R} 160 may be used for run-time inference, where M-helper 140 can provide editing capabilities to enhance the memorability score of an input image. The M-helper 140 may help identify specific sub-images of the input image that are worth editing, for example, creating an advertisement in an interactive way, based on the predicted relative memorability information (discussed below).

### B. Image Preparation

In FIG. 1, the input images 104 (e.g., two-dimensional images) may be color images, grayscale images, video frames (e.g., images from a video), augmented images, synthetic images, etc. In some embodiments, the images may be in an image file. An image may contain various objects, and in various sizes. The image preparation module 110 may prepare images to be processed by M-core 120, M-helper 140, and DR 160. In some embodiments, an input image may be resized to a fixed width and height (e.g., F×F, where Fis 384 pixels), before it is processed by a dicing module 112, and the models (120, 140, and 160) in the MIMNet.

A dicing module 112, as part of the image preparation 110, may perform a dicing operation that randomly partitions the input image 104 into a number of sub-images (i.e., randomly diced images) that may not be equal in size (e.g., height×width). The diced height and width (during dicing) are constrained to be within a pre-programmed range [m, M], called range threshold, with a lower boundary and an upper boundary of a number of pixels (e.g., a minimum/lower boundary m=96 pixels and a maximum/upper boundary M=192 pixels). As a result, the maximum number of sub-images (i.e., diced images) can be (F/m)². For example, for an input image of 384×384 pixels, the maximum number of diced images would be 16, or 4 (in x-direction) and 4 (in y-direction).

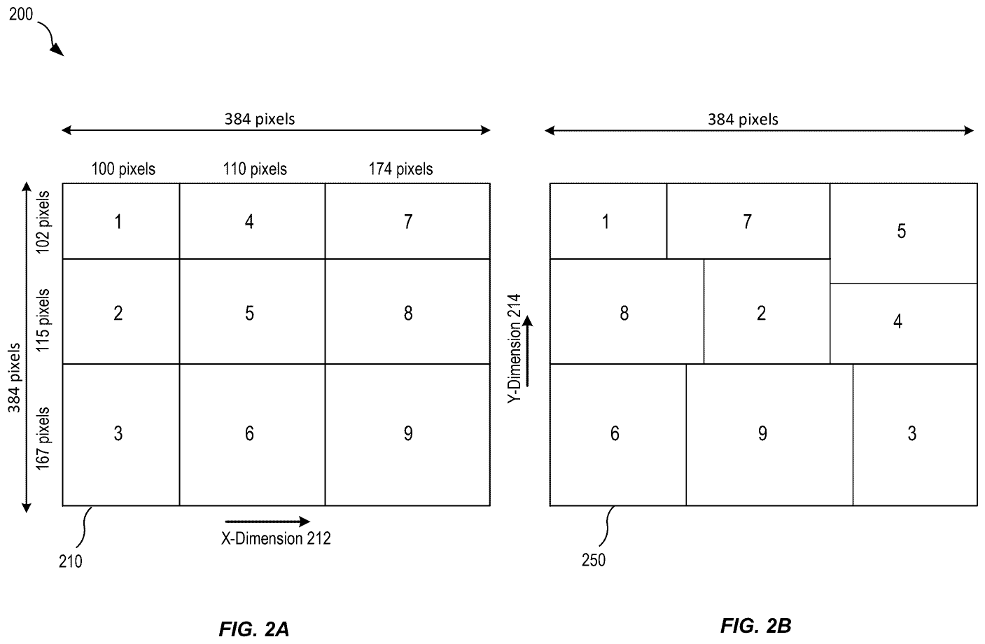

Referring to FIGS. 2A-2B, which are example diagrams of image dicing techniques, according to certain embodiments. In some embodiments, each dimension of a two-dimensional (2D) image 210 may be diced independently, and then combined into 2D diced images (or sub-images). For example, as shown in FIG. 2A, in the x-dimension, the 384 pixels may be randomly partitioned into 3 segments, 100 pixels (0-100), 110 pixels (101-210), and 174 pixels (210-384). In the y-dimension, the 384 pixels may be randomly partitioned into another 3 segments, 102 pixels (0-102), 115 pixels (103-217), 167 pixels (218-384). As a result, 9 sub-images/diced images can be generated with the following sizes for each of sub-images 1-9 (e.g., 100×102 pixels for sub-image 1, 100×115 pixels for sub-image 2, 100×167 pixels for sub-image 3, 110×102 pixels for sub-image 4, . . . , 174×115 pixels for sub-image 8, and 174×167 pixels for sub-image 9), respectively. In other words, each segment in a dimension has a range between 96˜192 pixels, and accordingly, each dimension can have between 2 to 4 segments because (384/192=2) and (384/96=4). During the dicing process, a random number between 96˜192 is chosen to determine the size of each segment in a dimension, while considering the overall size in that dimension. Therefore, it is possible that some sub-images (or diced images) have the same size (e.g., the same random number for each dimension), or all sub-images have different sizes.

In some embodiments, the diced images (or sub-images) may be re-arranged or re-oriented randomly in the main image 250 to further capture different parts of the main image. For example, the 9 diced images discussed in the above example may be randomly re-arranged or re-oriented to not align with each other, as shown in FIG. 2B. After the re-arrangement, all sub-images 1-9 may still be within the boundary of the main image. For example, in FIG. 2B, the positions of sub-images 1, 4 and 7 may have changed from their original positions in FIG. 2A, but their sum in x-dimension can still equal 384 pixels. As another example, in FIG. 2B, the positions of sub-images 1, 6 and 8 may have changed from their original positions in FIG. 2A, but their sum in y-dimension can still equal 384 pixels. In other embodiments, if one sub-image is re-oriented, for example, rotating 90-degree, one or more other sub-images may also be re-oriented to fit in the boundary of the main image.

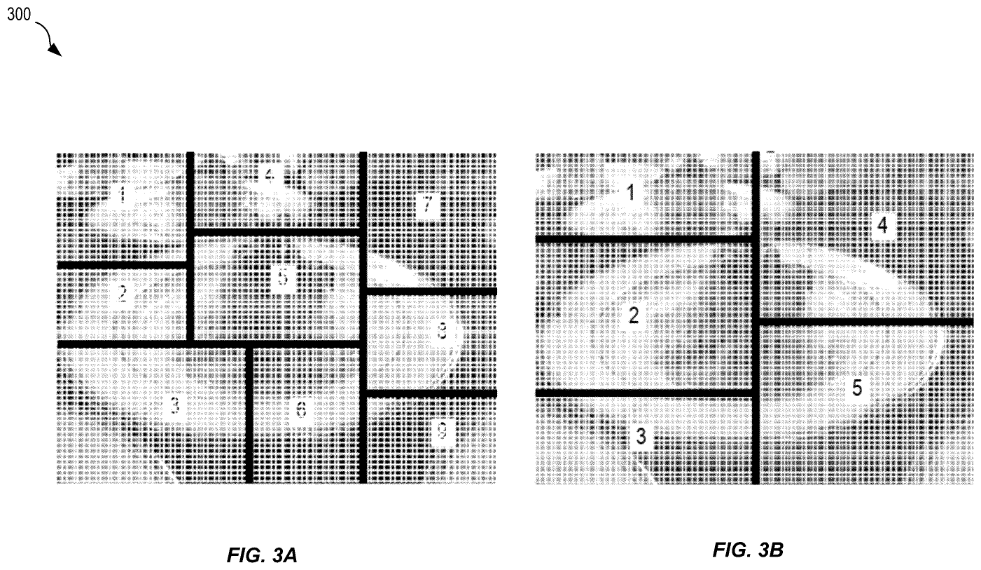

Referring to FIGS. 3A-3B, which are example diagrams of image dicing techniques, according to certain embodiments. In some embodiments, the re-arrangement of the randomly diced images may be performed based on an arrangement configuration that considers the objects in the main image and the sizes of the diced images to achieve a higher probability of dicing (or partitioning) more objects or a higher probability of having one diced/sub-image image covering more objects. For example, in areas of the main image that contain more objects, smaller randomly diced images may be moved to these areas so that more objects can have a higher probability of being diced (or partitioned). In such a scenario, the input main image may be pre-processed (e.g., by image recognition software) to detect areas with objects and the number of objects. That detected information may be provided to the dicing module 112 accordingly. In other embodiments, the opposite approach may be performed, such that a larger diced image may have a higher probability of covering more objects.

Such re-arrangement may involve dividing the main image into a few equal regions (e.g., four equal parts-upper left region, upper right region, lower left region, and lower right region). The total number of objects and the regions in which these objects are located may also be determined. A region that has a higher number of objects can then be identified. The randomly partitioned sub-images may then be re-arranged or moved around depending on the arrangement configuration. To have a higher probability of dicing (or partitioning) more objects, smaller sub-images can be moved into or closer to a region containing a higher number of objects. To have a higher probability of having one sub-image covering more objects, one or more larger sub-images can be moved into or closer to a region containing a higher number of objects. For example, in FIG. 3A, the upper left region contains three objects (e.g., cakes). Accordingly, four smaller sub-images 1, 2, 4, and 5 of the nine sub-images (i.e., diced images) may be moved closer to that region.

In some embodiments, the dicing process may look at the objects in the main image and be configured (based on a partition configuration) to randomly partition in certain regions but have pre-defined partitions in other regions. For example, a region containing an object may be designated for a pre-defined partition (an example of a first sub-image) to preserve (or overlap) an object while other regions are randomly partitioned. As shown in FIG. 3A, a cake in sub-image 5 is preserved, while the rest of the main image is randomly partitioned as sub-images 1-4 and 6-9. A pre-defined partition may be created by setting a segment of the x-dimension to a particular length, and setting a segment of the y-dimension to another particular length, such that the region (or a sub-image) created by these two fixed segments (i.e., width and height) can sufficiently cover or overlap an object (e.g., a cake).

On the other hand, the region containing an object may be designated to be randomly partitioned while other regions are fixed partitioned. For example, in FIG. 3B, the right-half has pre-defined partitions of two sub-images 4 and 5, while the left-half is randomly partitioned into three sub-images 1-3 in different sizes. In further embodiments, two or more adjacent sub-images may be merged into one larger sub-image. For example, in FIG. 3A, sub-images 3, and 6 in FIG. 3A may be merged into a larger sub-image that may still be within the range threshold.

Referring back to FIG. 1, after the dicing process completes, each of the diced image may be resized to be the same size as the main image F×F (e.g., 384×384 pixels) via module 114 before providing to M-core 120, and via module 115 to M-helper 140. Thus, the MIMNet may operate the number of diced images plus the original input image. The image region that has been diced may be referred to as diced region, or cropped region (I_{C}).

The purpose of dicing is to determine the role played by a diced image (i.e., the individual pixels associated with the diced image) in the main image. In some embodiments, the dicing mechanism can help identify the importance (e.g., contribution of memorability) of a particular diced image to the main image, and allow one to edit a particular diced image to increase the overall memorability of the main image. Further details describing the editing of a diced image (or a sub-image) are described below.

### C. Components

Continuing with FIG. 1, M-core 120, as a vision transformer, may include sub-modules (together as an encoder), such as a multi-head attention (M_{H}), add and norm (N_{S}), a feed-forward layered network (M_{L}). The M-core 120 may be responsible for calculating the overall memorability score per image it receives. An M_{H} sub-module may allow the model to simultaneously focus on different aspects of an image by using multiple parallel attention mechanisms, enabling it to capture diverse relationships and features across image patches for improved visual understanding. The add and norm (N) sub-module may combine a residual connection (e.g., maintaining flow of visual information through network layers) with layer normalization. The M_{L} sub-module may process and transform features output by the attention mechanism, introducing non-linearity and increasing model capacity to learn complex patterns. The multi-head self-attention mechanism may help calculate attention weights to prioritize input sequence elements during predictions.

The M-helper 140 may have similar architecture to the M-core 120, but have an additional sub-module, attention map block (A_{M}) (also referred to herein as attention pass) 150, allowing interaction (called attention passage, discussed below) between both models, M-core and M-helper. The M-helper 140 may be responsible for calculating the memorability score of individual diced images. The M-core 120 may receive resized images of both the main image 104 and the randomly diced 106 images from module 114. The M-helper 140 may receive the resized images of the randomly diced 106 images via module 115.

As discussed above, the A_{M} may allow interaction between M-core 120 and M-helper 140. The A_{M} may be configured to map the attention from M-core 120 to M-helper 140, such that the MIMNet can understand the overall memorability in terms of memorability of sub-images. In other words, the M-core may provide additional attention information (e.g., pre-attention 152) to the M-helper, so that the M-helper understands the importance of the sub-image towards memorability. For example, M-core 120 may receive a main image containing two objects (e.g., a dog and a cat), and calculate the memorability score of the main image. A diced image may be generated based on the main image but contain only one of the objects (e.g., the dog). When the M-core receives this diced image containing the dog only, it can also calculate the memorability score of the dog-only sub-image. This information (e.g., pre-attention information for calculating memorability scores of the main image and the dog-only sub-image) can be passed from the M-core 120 to the M-helper 140 through the A_{M} 150. The pre-attention information may refer to data processed before the attention mechanism (e.g., enabling a model to pay attention to or focus on different parts of an input image, such as prioritizing certain image patches) is applied by a ViT (e.g., M-core 120 or M-helper 140) by transforming input image data into a format suitable for attention computation. As a result, the M-helper 140 can estimate what role (or contribution) the dog object plays toward the overall memorability of the input image. Further details about attention pass are described below.

Since M-core 120 receives both the main image 104 and the randomly diced images 106, it may predict and output standalone memorability 172 (denoted as g(I)) of the main image 104 (denoted as I), and additionally the standalone memorability 174 of each diced image (or referred to as cropped image from dicing). In some instances, a cropped or diced image can have higher memorability than the original image (i.e., the input image before dicing) because cropping may lead to a gain in focus on these sub-regions.

The output 176 of M-helper 140 may be referred to as relative memorability, also called a memorability booster signal, which is the output of a signal booster function (described below) taking the diced image (or cropped image) and the main image as inputs. The relative memorability 176 may indicate the memorability contribution of a sub-image in the main image. If the ratio of the area of cropped image to the main image is close to 1, the relative memorability of cropped image should be similar to the memorability of the main image. Thus, the purpose of M-helper may be to model the role played by sub-images when they are part of any larger image, and identify whether a sub-image is effective enough in terms of impacting overall memorability. The sub-image may be neutral, positively interacting, or negatively interacting with the rest of the pixels in the main image in which it is partitioned (or diced).

In some embodiments, relative memorability may be deemed or represented as a relative weight for a particular sub-image compared to other sub-images of the same main image. Some sub-images may have higher weights, and some have lower weights. However, the sum of all weights need not equal to one. For example, the standalone memorability of the main image may be 40%, while the standalone memorability of a sub-image 1 (e.g., a cake) and a sub-image 2 (e.g., an apple) are 60% and 30%, respectively. In that case, the relative memorability generated by the M-helper for the sub-image 1 may be higher than that for sub-image 2, such as a weight of 0.2 for sub-image 1 and a weight of 0.1 for sub-image 2. This also indicates that sub-image 1 may have more memorability contribution (or strength) and, thus play a more important role than sub-image 2 in the main image.

The following equation #1 containing two sub-equation #1.1 and sub-equation #1.2 may represent or model the relative memorability, which is the memorability contribution (mᵣ) of a sub-image (I_{C}) in the main image (I).

$$( Equation \#1 \text{.1} and \#1 \text{.2} )$$

$${m}_{r} ∼ m exp [ - ( 1 - {A}_{r} ) ℬ ( {ℐ}_{c} , a ( ℐ ) ) ]$$

$${m}_{r} ∼ {m}_{c} exp [ - ( 1 - {A}_{r} ) ℬ ( {ℐ}_{c} , a ( {ℐ}_{c} ) ) ]$$

In equation #1 above, B( ) is a signal booster function. a(I) is the tapped attention for a given image I. Ar is the ratio of the area of the cropped image (i.e., diced image, I_{C}) to the main Image (I). m is the memorability of the main image. Mc is the memorability of a cropped image. If Ar is close to 1, the relative memorability of the cropped image should be similar to the memorability of the main image. Further, the role played by sub-image towards memorability becomes smaller when Ar is close to zero.

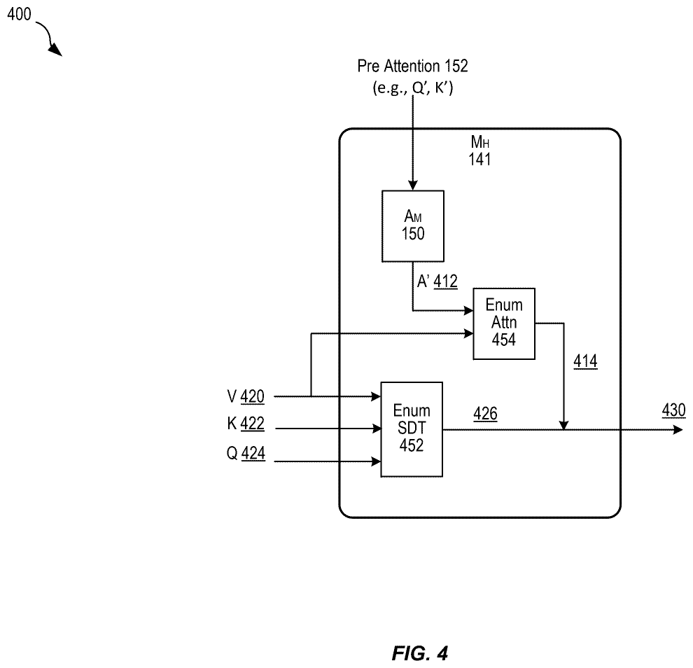

Equation #1 represents two ways/approaches to modeling relative memorability. The first one (equation #1.1) involves pre-attention associated with the main image (a(I)). The attention that is paid to different patches within the main image is captured. In B(I_{C}, a(I)), I_{C} works as a key to extract pre-attention from a(I), such that the memorability of I_{C} towards I can be ascertained. The main memorability, m, factors in for the contribution of sub-images cannot exceed m. This approach may correspond to the attention pass (e.g., 414 of FIG. 4) to be discussed below.

The second one (equation #1.2) involves cropped image (I_{C}) only, and may consider that the interaction strength of a sub-image is one characteristics. It helps in balancing any bias which may be introduced because of attention flowing from the main image (I) to the cropped image (I_{C}). This approach may correspond to path 426 of FIG. 4 to be discussed below. Both sub-equations #1.1 and #1.2 may be combined to become equation #2 below:

$$( Equation \#2 )$$

$$m \approx {m}_{c} exp [ - ( 1 - {A}_{r} ) ( ℬ ( {ℐ}_{c} , a ( {ℐ}_{c} ) ) - ℬ ( {ℐ}_{c} , a ( ℐ ) ) ) ]$$

When the relative memorability (mᵣ) of all cropped images (referred to as S(I), the stack of diced or resized images I_{C}) are summed together while taking into account Ar for the relative size represented by the cropped region, the result may be close to memorability (m) of the main image, as shown in equation #3 below. In other words, equation #3 may be a weighted sum of cropped images by considering their respective area ratio of the main image.

$$m ∼ {\sum }_{{ℐ}_{c} ∈ 𝒮 ( ℐ )} {A}_{r} {m}_{r} {ℐ}_{c} \qquad ( Equation \#3 )$$

The D_{R} 160 may be a dilated fully convolutional ResNet-based network, which can combine dilated convolutions with residual connections to improve performance on tasks like image classification and segmentation. The dilated ResNet can output height and width that are unchanged at each layer of this ResNet. Thus, for an input image (I) of dimension 384×384 pixels, the height and width at each layer of the ResNet remain at 384×384. The D_{R} 160 maps an image to a single-channel output (referred to as D(I)) to be modeled as a memorability map. The D_{R} 160 may receive pixels 108 of the input image 104, and output values of integrable memorability map per pixel 178, such that the model (D_{R} 160) can identify the role contributed by individual pixels towards the overall memorability. In some embodiments, D_{R} 160 may also receive pixels of the diced images 106.

$$m \approx {\sum }_{i , j ∈ [ P ]} ℋ ( 𝒟 ( ℐ ) ) \qquad ( Equation \#4 )$$

The above equation #4 may indicate that memorability map may have some constraints imposed by a shape-preserving function H( ) on the output D(I). P may equal the height or width of the input image.

Additionally, The summation (or integration) of the values in the memorability map for all pixels may equal the overall image memorability (M_{I}). This may be represented in equation #5 shown below:

$${m}_{ℐ} = {\int }_{ℐ} f ( x , y ) dxdy \qquad ( Equation \#5 )$$

In the above equation #5, the 2D function f(x,y) represents values (also referred to herein as memorability density) in the memorability map for pixels in a 2D location x and y. M_{I} is the overall image memorability.

Finally, the cropped sections (during image preparation with dicing) of the input image may also have some constraints imposed by the shape-preserving function H( ) on the output D(I), as shown in equation #6 below:

$${A}_{r} {m}_{ℓ} {ℐ}_{c} \approx {\sum }_{i , j ∈ ℙ ( {ℐ}_{c} )} ℋ ( 𝒟 ( ℐ ) ) \qquad ( Equation \#6 )$$

In equation #6, P(I_{C}) may be the set of points in the input image (or main image, I) corresponding to cropped images (I_{C}). Equation #6 may indicate that the regions in the memorability map faithfully represent memorability even at the local level (e.g., individual diced images).

The output 190, the final memorability score, of the MIMNet may be based on a combination of individual outputs from the three models, M-core 120, M-helper 140, and D_{R} 160. The V_{R} module 180, a regression feature unit, may combine the outputs of the three models, M-core 120, M-helper 140, D_{R} 160. In some embodiments, V_{R} module 180 may post-process the integrable memorability map per pixel 178 to generate an integrated per-pixel memorability score by integrating all values in the memorability map per pixel produced by D_{R} 160, as shown in equation #5 above. The V_{R} module 180 may also post-process the standalone memorability 174 of each diced image and relative memorability 176 of each diced image to generate an integrated diced memorability score by integrating all values of the diced images, as shown in equation #3 above.

The C_{R} submodule 182 in the V_{R} module 180 may be a combinator that combines the standalone memorability of a diced image 174 (denoted as g(I_{C})) and its relative memorability 176 (or the memorability booster signal, B(I_{C}, a(I)). In some embodiments, the ViTs (i.e., M-core 120, M-helper 140) may output scalars or vectors. In situations where the two ViTs output vectors, the V_{R} module (or called layer) 180 can fuse them into a single scalar output 190.

The V_{R} module 180 may be viewed as gathering standalone memorability (denoted as g (I)) for the main image and standalone memorability of diced images (denoted as K(I_{C})) for the diced images to produces a tensor with a shape (#S(I)+1, . . . ), where #S(I) refers to the number of diced images.

### D. Attention Pass

FIG. 4 is a simplified block diagram illustrating an attention map layer (A_{M}) in a vision transformer for the MIMNet architecture, according to certain embodiments.

In a ViT, a received image may be converted into image patches, and then vectors, such as query (Q), key (K) and value (V), are generated based on each image patch for attention mechanism through learned linear transformations. A query may represent the information that is being looked for. A key or a set of keys may represent the context or reference, and a value may be the content that matches the information provided in the query. As discussed earlier in relation to FIG. 1, MIMNet may allow interaction between M-core 120 and M-helper 140 through A_{M} 150. During the interaction, information, called pre-attention 152 may be passed from M_{H} 121 of the M-core 120 to an attention map A_{M} 150 residing in the M_{H} 141 of the M-helper 140. The pre-attention 410 may be the query (Q′) and key (K′) generated by the M-core 120, and the attention map A_{M} may act as a liner projector. The purpose of A_{M} 150 may be to map pre-attention 410 into a tensor 412 dimensionally compatible with the value (V) within the M-helper 140. The pre-attention 410 may be generated based on the input image (or main image) 104 and diced images 106.

As shown in FIG. 4, a sub-module, Enum SDT 452, may receive a set of value (V) 420, key (K) 422, and query (Q) 424 generated from each diced image 106, and enumerate the scaled dot product (denoted as II) of these V, K, and Q to calculate attention, resulting in an output 426 (denoted as Πₜ (Q, K, V)). Another sub-module, Enum Attn 454, may enumerate attention corresponding to V 420 and output A′ 412 (i.e., query-key value) of A_{M} 150 to become output 414 (denoted as Π_{c} (A′, V)). The output value 414 and output value 426 are summed together to become Π_{c} (A′, V)+Πₜ (Q, K, V). Thus, the output 430 of the multi-head attention layer in the M-helper 140 is

$${\prod }_{c} ( {A}_{M} ( pre attention ( {Q}^{’} , {K}^{’} ) ) , V ) + {\prod }_{t} ( Q , K , V )$$

In other words, the M-core 120 may provide pre-attention information (e.g., pre-attention (Q′, K′)) to M-helper, so that M-helper 140 understands the importance of the sub-image towards memorability.

For example, suppose a main image contains a cake and an apple. The M-core 120 estimates the standalone memorability of the main image to be 40%. Two diced images received by the M-core 120 are estimated to have standalone memorability scores to be 60% (for the cake) and 30% (for the apple), respectively. When information indicating a particular diced image is estimated to have lower, same, or higher standalone memorability than the main image, such information is passed in the form of pre-attention (e.g., 152, such as query (Q) and key (K) for ViT processing) from the M-core 120 to the M-helper 140. The M-helper, receiving diced images only, can understand the individual diced image containing only cake contributes more to (or plays a more important role in) the main image (e.g., overall main image 40% v. cake only 60%) and generates relative memorability.

With this information about relative memorability, in some embodiments, one may edit (e.g., change the size of the object) the diced image containing only the apple to increase the final overall memorability 190 (an example of the characteristics) of the input image. For example, editing the apple-only sub-image (or diced image) may involve increasing the size or proportion of the apple, changing brightness or colors, etc., such that the object with a lower standalone memorability score (e.g., apple) may become more prominent in the main image.

### E. Process Flows

### 1. Operation

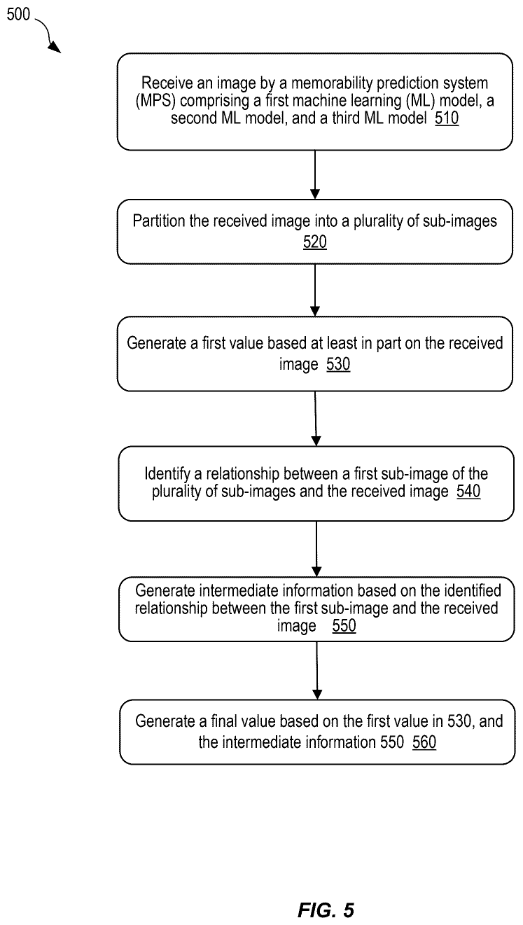

FIG. 5 is an example flowchart illustrating processing performed by a MIMNet, according to certain embodiments. The processing depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 5 and described below is intended to be illustrative and non-limiting.

Although FIG. 5 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 5 may include a greater number or a lesser number of steps than those depicted in FIG. 5.

At step 510, an image may be received by a memorability prediction system (MPS) comprising a first machine learning (ML) model, a second ML model, and a third ML model. For example, in FIG. 1, input main image 104 is obtained by MPS 101 that includes a trained memory interaction map network (MIMNet) 102. The MIMNet 102 (i.e., the ML model) may further include ML models, such as M-core 120, M-helper 140, and D_{R} 160.

At step 520, the received image may be partitioned into a plurality of sub-images. For example, in FIG. 1, the dicing module 112 may partition the input image 104 into two or more sub-images (i.e., the diced images) as shown in FIGS. 2A and 2B. For a main image of 384×384 pixels, if the range threshold is set to between 96 and 192 pixels, the number of sub-images may be between 4 and 16.

At step 530, a first value may be generated based at least in part on the received image. For example, in FIG. 1, the M-core 120 may receive the input image 104 (or the main image) and generate a predicted standalone memorability 172 of the input main image 104.

At step 540, a relationship between a first sub-image of the plurality of sub-images and the received image may be identified. For example, in FIG. 1, the M-core 120 may receive one (i.e., the first sub-image) of the diced images 106 that has been resized, identify the relationship information (e.g., estimated memorability strength/scores) between the first sub-image and the main image in the form of pre-attention 152, which is then passed to M-helper 140. The M-helper 140 may also receive the same diced images 106. The M_{H} 141 of the M-helper 140 may identify the memorability contribution of the first sub-image to the main image using the attention map A_{M} 150 (shown in FIG. 4).

At step 550, an intermediate information may be generated based on the identified relationship in 540 between the first sub-image and the received image. For example, in FIG. 1, the M-helper 140 may use the information related to the identified memorability contribution (e.g., 152 and 430 of FIG. 4) to generate relative memorability 176 as an intermediate information. In some embodiments, the intermediate information may also include the predicted standalone memorability 174 for the first sub-image generated by the M-core 120 and memorability map per pixel 178 generated by the D_{R} 160.

At step 560, a final value may be generated based at least in part on the first value in 530, and the intermediate information in 550. For example, in FIG. 1, the V_{R} module 180 may integrate standalone memorability 174 and relative memorability 176 for all sub-images to result in an integrated diced memorability score via C_{R} 182. The V_{R} module 180 may integrate memorability density (i.e., values of memorability map per pixel 178) for all pixels to result in an integrated memorability map per pixel (e.g., an overall image memorability from the pixel's perspective). A final memorability score 190 (an example of the final value) may be generated based on the standalone memorability 172 of the main image 104, the integrated diced memorability score, and the integrated memorability map per pixel.

### 2. Dicing Flow

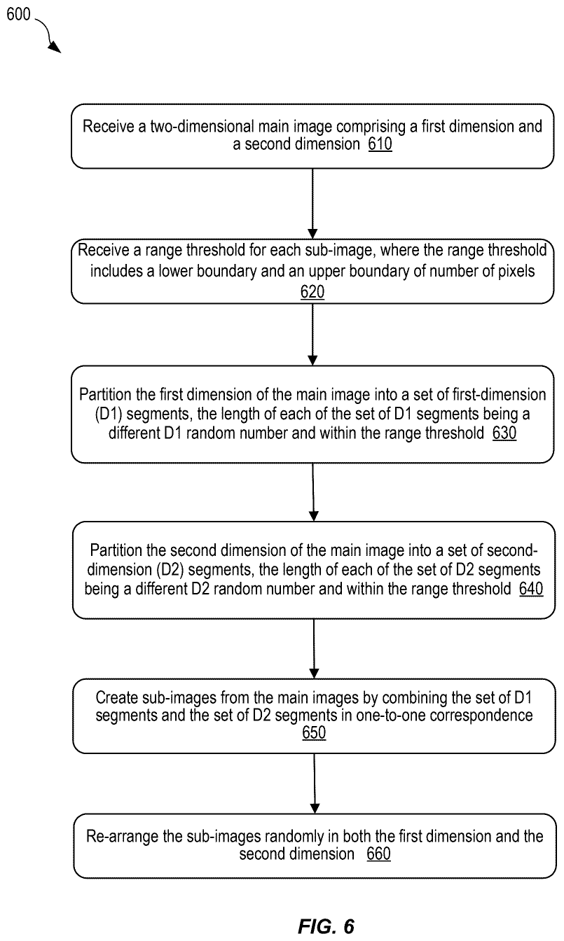

FIG. 6 is an example flowchart illustrating a method of image dicing, according to certain embodiments. The processing depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 6 and described below are intended to be illustrative and non-limiting. Although FIG. 6 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 6 may include a greater number or a lesser number of steps than those depicted in FIG. 6.

At step 610, a two-dimensional main image comprising a first dimension, a second dimension, and one or more objects may be received. For example, in FIG. 2A, a two-dimensional main image 210 with 384×384 pixels may be received by the MPS. The two-dimensional main image 210 may include an x-dimension 212 (i.e., the first dimension) and a y-dimension 214 (i.e., the second dimension). An example size of the main image may be 384×384 pixels. The main image may include one or more objects such as shown in FIGS. 3A and 3B.

At step 620, a range threshold may be received. The range threshold may have a lower boundary and an upper boundary of number of pixels. The range threshold may be used as a constraint for partitioning the main image into a plurality of sub-images. As mentioned above, the range threshold is the range for the height and width of each partition (or sub-image), for example, a minimum number m (e.g., 96 pixels) and a maximum number M (e.g., 192 pixels).

As step 630, the first dimension of the main image may be partitioned into a set of first-dimension (D1) segments, and the length of each of the set of D1 segments may be a different D1 random number and be within the range threshold. For example, in FIG. 2A, the x-dimension 212 of the main image 210 may be partitioned into three segments (e.g., widths of the sub-images 1, 4, and 7). The lengths (i.e., the width) of the sub-images 1, 4, and 7 may be different random numbers, 100 pixels, 110 pixels, and 174 pixels, respectively, which are all within the range threshold (i.e., between 96 pixels and 192 pixels).

At step 640, the second dimension of the main image may be partitioned into a set of second-dimension (D2) segments, the length of each of the set of D2 segments being a different D2 random number and within the range threshold. For example, in FIG. 2A, the y-dimension 214 of the main image 210 may be partitioned into three segments (e.g., widths of the sub-images 1, 2, and 3). The lengths (i.e., the width) of the sub-images 1, 2, and 3 may be different random numbers, 102 pixels, 115 pixels, and 167 pixels, respectively, which are all within the range threshold (i.e., between 96 pixels and 192 pixels).

At step 650, sub-images from the main images may be created by combining the set of D1 segments and the set of D2 segments in one-to-one correspondence. For example, in FIG. 2A, the first D1 (x-dimension) segment may be combined with the first D2 (y-dimension) segment to become the sub-image 1 with “width×height” equaling 100×102 pixels. As another example, the second D1 (x-dimension) segment may be combined with the second D2 (y-dimension) segment to become the sub-image 5 with “width×height” equaling 110×115 pixels. Yet another example, the third D1 (x-dimension) segment may be combined with the third D2 (y-dimension) segment to become the sub-image 9 with “width×height” equaling 174×167 pixels.

At step 660, the sub-images may be randomly re-arranged in both the first dimension and the second dimension. For example, in FIGS. 2A and 2B, the sub-image 7 may be moved from the upper-right corner to the upper-middle position. The sub-image 5 may be moved from the center position to the upper-right position. The sub-images 3, 6, and 9 in bottom-left, middle, and right positions may be re-arranged to become bottom-right, left, and middle positions, respectively.

### 3. Memorability Interaction Flow

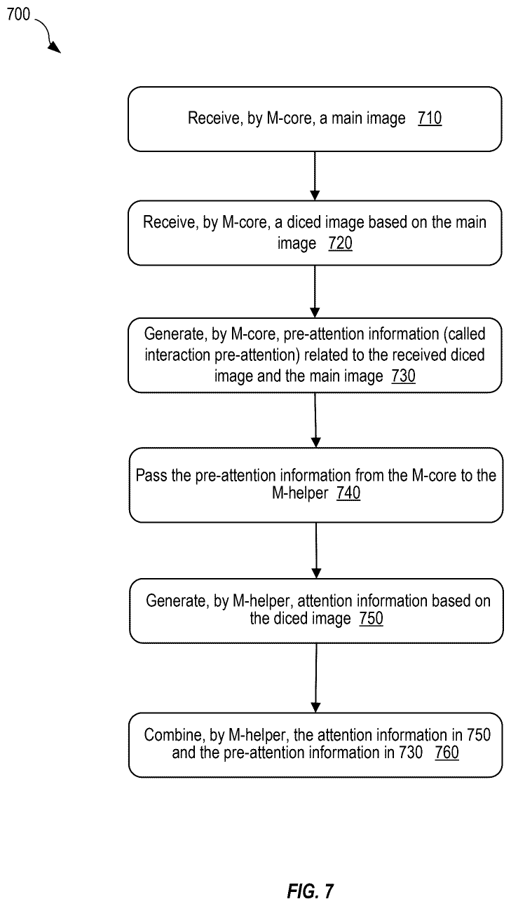

FIG. 7 is an example flowchart illustrating a method for memorability interaction (called attention pass) used in a MIMNet, according to certain embodiments. The processing depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 7 may include a greater number or a lesser number of steps than those depicted in FIG. 7.

At step 710, an input main image may be received. For example, in FIG. 1, an input main image 104 may be received by M-core 120.

At step 720, a diced image based on the main image may be received. For example, in FIG. 1, a diced image (or a partitioned sub-image) 106 based on the main image 104 may be received by M-core 120 through module 114 that resized the diced image 106 to be the same size as the main image F×F (e.g., 384×384 pixels).

At step 730, pre-attention information (e.g., pre-attention) related to the received diced image in 720 and the main image in 710 may be generated. For example, as discussed in FIG. 1, pre-attention information (e.g., data prepared before the attention mechanism is applied by a ViT) for calculating memorability scores of the main image and the diced image may be generated by M_{H} 121 of the M-core 120. The pre-attention information may be in the form of query (Q′) and key (K′), as shown in FIG. 4.

At step 740, the pre-attention information in 730 may be passed from the M-core to the M-helper. For example, in FIGS. 1 and 4, the pre-attention information 152 may be passed from the M-core 120 to the A_{M} 150 block in the M-helper 140. Such interaction between the M-core 120 and the M-helper 140 can allow MIMNet 102 to observe the relationship between a particular part (i.e., the diced image) of the main image and the main image, and determine its significance (or importance) of that part.

At step 750, attention information may be generated by M-helper based on the diced image. For example, in FIG. 4, M_{H} 141 of the M-helper 140 may calculate attention information 426 based on the diced image 106.

At step 760, the attention information in 750 and the pre-attention information in 730 may be combined by the M-helper. For example, in FIG. 4, M_{H} 141 of the M-helper 140 may combine attention information 426 based on the diced image 106 only and the information 414 post-processed by attention map A_{M} 150 and Enum Attn 454 based on the main image and the diced image.

### F. Training Environment

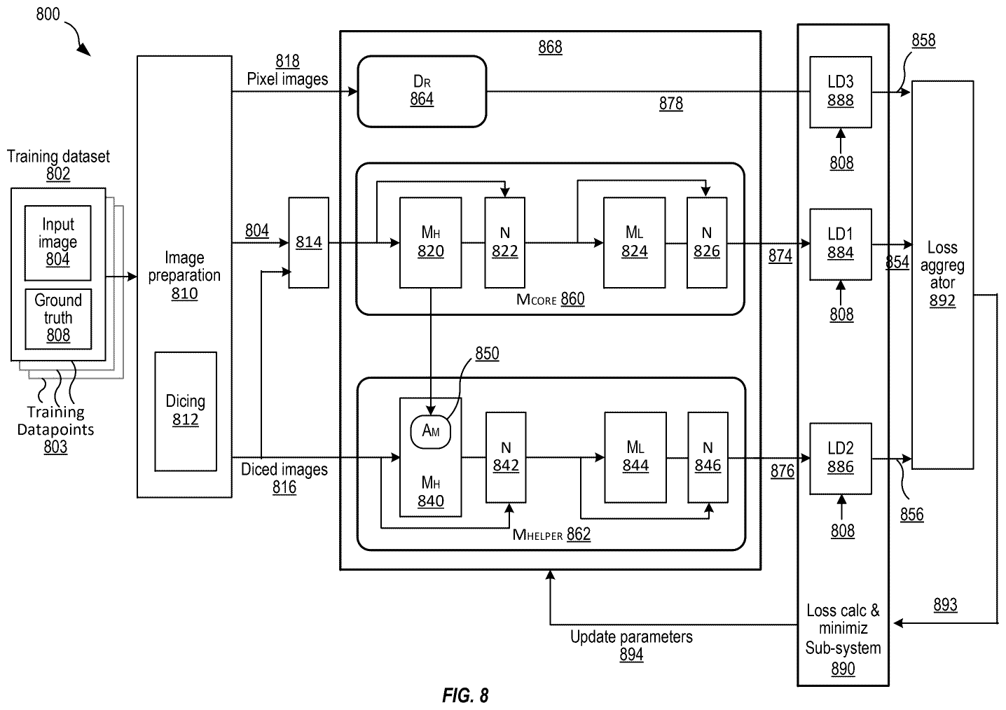

FIG. 8 is a simplified block diagram of a training environment 800 that may be used to train a memory interaction map network (MIMNet), according to certain embodiments. Distributed environment 800 depicted in FIG. 8 is merely an example and is not intended to unduly limit the scope of claimed embodiments. Many variations, alternatives, and modifications are possible. For example, in some implementations, distributed environment 100 may have more or fewer systems or components than those shown in FIG. 8, may combine two or more systems, or may have a different configuration or arrangement of systems. The systems, subsystems, and other components depicted in FIG. 8 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As shown in FIG. 8, a training dataset 802 comprising multiple training datapoints 803 may be used to train a MIMNet 868. Each training datapoint 803 may include input images 804 (or training images), and ground truth 808. The input images 804 are provided to the image preparation module 810 to prepare the diced images 816 using the dicing module 812. The outputs of the image preparation module 810, main training image 804 (same as the input image), diced images 816 (i.e., training sub-images), and pixel images 818, are provided to the MIMNet for training. Dicing is performed so that the memorability map can capture all local aspects by attending to random regions partitioned from the main image 804. In some embodiments, the main training image 804 may be diced in a different way for each training iteration, according to the dicing mechanism described above in relation to FIGS. 2A, 2B, 3A, and 3B.

The ground truth 808 is provided as an input to a loss calculation and loss minimization sub-system 890. Loss calculation and loss minimization sub-system include several loss determiners (LD1 884, LD2 286, and LD3 888) that receive the output predictions of MIMNet 868 and the ground truth information 808. In some embodiments, the ground truth 808 may contain a memorability score for the main training image 804 of a datapoint 803. The LDs then calculate a loss value 854 for M-core's prediction 874, a loss value 856 for M-helper's prediction 876, and a loss value 858 for D_{R}'s prediction 878. The loss is a value indicative of how much the prediction of each model deviates from the ground truth for that model.

There are three types of losses, M-core loss (or called core prediction loss, i.e., loss value 854 for M-core's prediction 874), M-helper loss (i.e., loss value 856 for M-helper's prediction 876), and D_{R} loss (i.e., loss value 858 for D_{R}'s prediction 878).

The M-core loss 854 (denoted as Lp(I)) may be represented by the following equation #7:

$${ℒ}_{p} ( ℐ ) = {( 𝒢 ( ℐ ) - m )}^{2} + {\sum }_{{ℐ}_{c} ∈ 𝒮 ( ℐ )} {( K ( {ℐ}_{c} ) - m )}^{2} \qquad ( Equation \#7 )$$

In equation #7, g(I)) is the standalone memorability of the main image (I). m is the target memorability score (i.e., the ground truth information 808). K(I_{C}) is the standalone memorability of diced images, and can be represented as equation #8 below, which may be equivalent to equation #2 above:

$$K ( {ℐ}_{c} ) = {m}_{c} exp [ - ( 1 - {A}_{r} ) ( ℬ ( {ℐ}_{c} , a ( {ℐ}_{c} ) ) - ℬ ( {ℐ}_{c} , a ( ℐ ) ) ) ] \qquad ( Equation 8 )$$

If the M-core and M-helper output a scalar only for each image, then for each Image we may get a vector of length #S(I)+1, each of them predicting the same target memorability scores m. Thus, the M-core loss (Lp(I)) can be represented as equation #7 above.

The M-helper loss 856 (denoted as Lm(I)) due to relative memorability score prediction may be represented as the following equation #9:

$${ℒ}_{m} ( ℐ ) = {( m - {\sum }_{{ℐ}_{c} ∈ 𝒮 ( ℐ )} {A}_{r , {ℐ}_{c}} m exp [ - ( 1 - {A}_{r , {ℐ}_{c}} ) ℬ ( {ℐ}_{c} , a ( ℐ ) ) ] )}^{2} + {( m - {\sum }_{{ℐ}_{c} ∈ 𝒮 ( ℐ )} {A}_{r , {ℐ}_{c}} m exp [ - ( 1 - {A}_{r , {ℐ}_{c}} ) ℬ ( {ℐ}_{c} , a ( {ℐ}_{c} ) ) ] )}^{2} \qquad ( Equation \#9 )$$

Equation #9 above may indicate that the sum of relative memorability scores of all diced images (or cropped images), represented in equation #3, should be close to the target memorability score (i.e., the ground truth information 808). In equation #9, the relative memorability (mᵣ) of equation #3 may be replaced by sub-equation #1.1 and sub-equation #1.2 to consider both ways of modeling relative memorability.

The D_{R} loss 858 (denoted as Ls(I)) due to the memorability map may be represented by the following equation #10:

$$( Equation \#10 )$$

$${ℒ}_{s} ( ℐ ) = {( m - {\sum }_{i , j ∈ [ P ]} ℋ ( 𝒟 ( ℐ ) ) )}^{2} + {\sum }_{{ℐ}_{c} ∈ 𝒮 ( ℐ )} {( {m}_{r} - ( {\sum }_{i , j ∈ ℙ ( {ℐ}_{c} )} ℋ ( 𝒟 ( ℐ ) ) ) )}^{2}$$

Equation #10 above, a combination of equation #4 and equation #6, may indicate that the sum of memorability at pixel level should be close to the overall memorability (i.e., memorability of main image (I)). The (mᵣ) in equation #10 can be from either sub-equation #1.1 or sub-equation #1.2.

The multiple losses (854, 856, and 858) calculated by the multiple LDs (LD1 884, LD2 286, and LD3 888) are then provided to a loss aggregator 892. Loss aggregator 892 is configured to aggregate the losses received from the multiple LDs and generate a final aggregated loss value 893 (denoted as L(I)) as shown in equation #11 below:

$$ℒ ( ℐ ) = {ℒ}_{p} ( ℐ ) + {ℒ}_{m} ( ℐ ) + {ℒ}_{s} ( ℐ ) \qquad ( Equation \#11 )$$

The aggregated loss 893 generated by loss aggregator 892 is then provided to the loss calc & loss minimization sub-system 890, which uses minimization techniques to minimize the loss. In certain implementations, backpropagation techniques are used to minimize the losses. As part of backpropagation processing, with each training iteration, the trainable parameters (e.g., weights) associated with the models (M-core 860, M-helper 862, and D_{R} 864) are updated to minimize the aggregated loss and improve performance. The process of calculating losses and updating trainable parameters may continue until the loss calculation & minimization sub-system 890 finds a set of model parameters that minimize the loss to within desired limits.

### 1. Flowchart

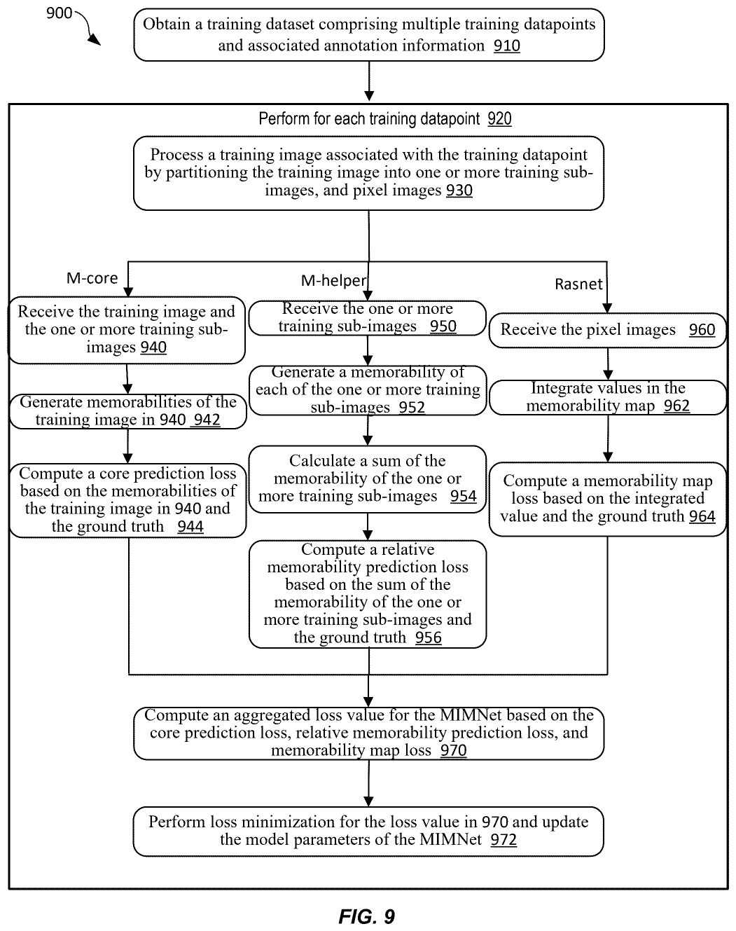

FIG. 9 is an example flowchart illustrating a method for training a memory interaction map network (MIMNet), according to certain embodiments. The processing depicted in FIG. 9 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 9 and described below is intended to be illustrative and non-limiting. Although FIG. 9 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 9 may include a greater number or a lesser number of steps than those depicted in FIG. 9.

At step 910, a training dataset comprising multiple training datapoints and associated annotation information (i.e., ground truth information) may be obtained. For example, in FIG. 8, a training dataset 802, comprising multiple training datapoints 804 may be obtained. Each training datapoint 803 may comprise an input training image 804, and ground truth 808, including the target memorability score for the input training image.

At step 920, the following steps, 930, and 940-972, are performed for each training datapoint. At step 930, a training image associated with the training datapoint may be processed by partitioning the training image into one or more training sub-images and pixel images. For example, in FIG. 8, the image preparation module 810 may process the main training image 804 to generate pixel images 818, the main training image 804 (may also be referred to as training image or main image in the training process), and diced images 816. These processed images may be provided to three models being trained, M-core 860, M-helper 862, and D_{R} 864, in the MIMNet 868, resulting in three different process flows in parallel.

Steps 940-944 describe the training process for M-core 860. At step 940, the training image and the one or more training sub-images 816 may be received by the M-core 860.

At step 942, the memorability of the images in 940 (i.e., training image (or main training image) and the one or more training sub-images (i.e., diced images or cropped images)) may be generated. For example, as described in relation to FIG. 8 and equation #7, the standalone memorability (g(I)) of the main image (I) and standalone memorability (K(I_{C})) of diced images may be generated and shown as output 874.

At step 944, a core prediction loss (i.e., M-core loss) may be based on the memorability of the training images in 940 and the ground truth, which is the target memorability score. For example, as described in relation to FIG. 8 and equation #7, the standalone memorability (g(I)) of main image (I) may be compared to the target memorability score 808 to calculate the loss for the main image. The standalone memorability (K(I_{C})) of all diced images may also be summed together and compared to the target memorability score 808 to calculate the loss for the diced images as a whole. These two losses may be then combined together to become the M-core loss 854, as shown in equation #7 above. The above process may be performed by LD1 884.

Steps 950-956 describe the training process for M-helper 862. At step 950, the one or more training sub-images 816 (i.e., diced images or cropped images)) may be received by the M-helper 862.

At step 952, the memorability of each of the one or more training sub-images may be generated. At step 954, a sum of the memorability of the one or more training sub-images may be calculated. For example, as described in relation to FIG. 8 and equation #9, the relative memorability for each sub-image (i.e., diced image or cropped image) may be generated and then summed together for all sub-images. Both approaches (e.g., equation #1.1 and equation #1.2) for generating the relative memorability are considered.

At step 956, a relative memorability prediction loss may be calculated based on the sum of the memorability of the one or more training sub-images and the ground truth. Continuing with the above steps, the summed relative memorability of the diced images for each of the two approaches (e.g., equation #1.1 and equation #1.2) may be compared to the target memorability score 808 by LD2 886, respectively, to result in loss for approach 1 (equation #15.1 below) and loss for approach 2 (equation #15.2 below).

$$( m - {\sum }_{{ℐ}_{c} ∈ 𝒮 ( ℐ )} {A}_{r , {ℐ}_{c}} m exp [ - ( 1 - {A}_{r , {ℐ}_{c}} ) ℬ ( {ℐ}_{c} , a ( ℐ ) ) ] ) \qquad ( Equation \#15 \text{.1} )$$

$$( m - {\sum }_{{ℐ}_{c} ∈ 𝒮 ( ℐ )} {A}_{r , {ℐ}_{c}} {m}_{c} exp [ - ( 1 - {A}_{r , {ℐ}_{c}} ) ℬ ( {ℐ}_{c} , a ( {ℐ}_{c} ) ) ] ) \qquad ( Equation \#15 \text{.2} )$$

The relative memorability losses for approach 1 and approach 2 are then summed together to calculate the loss (Lm(I)) for all diced images as a whole, as shown in equation #9 above.

Steps 960-964 describe the training process for D_{R} 864. At step 960, the pixel images 818 may be received by the D_{R} 864.

At step 962, values in the memorability map may be integrated. For example, as discussed above in relation to equation #5, the summation (or integration) of the values in the memorability map for all pixels may equal the overall image memorability (M_{I}).

At step 964, a memorability map loss may be calculated based on the integrated value and the ground truth. For example, as described in relation to FIG. 8 and equation #10, two types of memorability maps may be considered for both the main image (equation #4) and cropped images (or diced images) (equation #6). The memorability map for the main image (e.g., equation #4) may be compared to the target memorability score 808 to result in a memorability-map loss for main image. The memorability map for cropped images (or diced images) (e.g., equation #6) may be compared to the target memorability score 808 to result in a memorability-map loss for cropped images as a whole. Both types of memorability-map losses (for main image and cropped images) are summed together to calculate the overall memorability map loss (Ls (I)) 858, as shown in equation #10.

At step 970, an aggregated loss value for the MIMNet based on the core prediction loss, relative memorability prediction loss, and memorability map loss may be calculated (or computed). For example, in FIG. 8, core prediction loss 854, relative memorability prediction loss 856, and memorability map loss 858 may be aggregated by the loss aggregator 892 to generate an aggregated loss value 893, as shown in equation #11.

At step 972, loss minimization for the aggregated loss value in 970 may be performed and update the model parameters of the MIMNet. For example, in FIG. 8, aggregated loss value 893 may be received by the loss minimization sub-system 890 to perform loss minimization and update the model parameters of various models (M-core 860, M-helper 862, and D_{R} 864) in the MIMNet 868.

### II. Example Cloud Service Provider Infrastructure (CSPI) Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

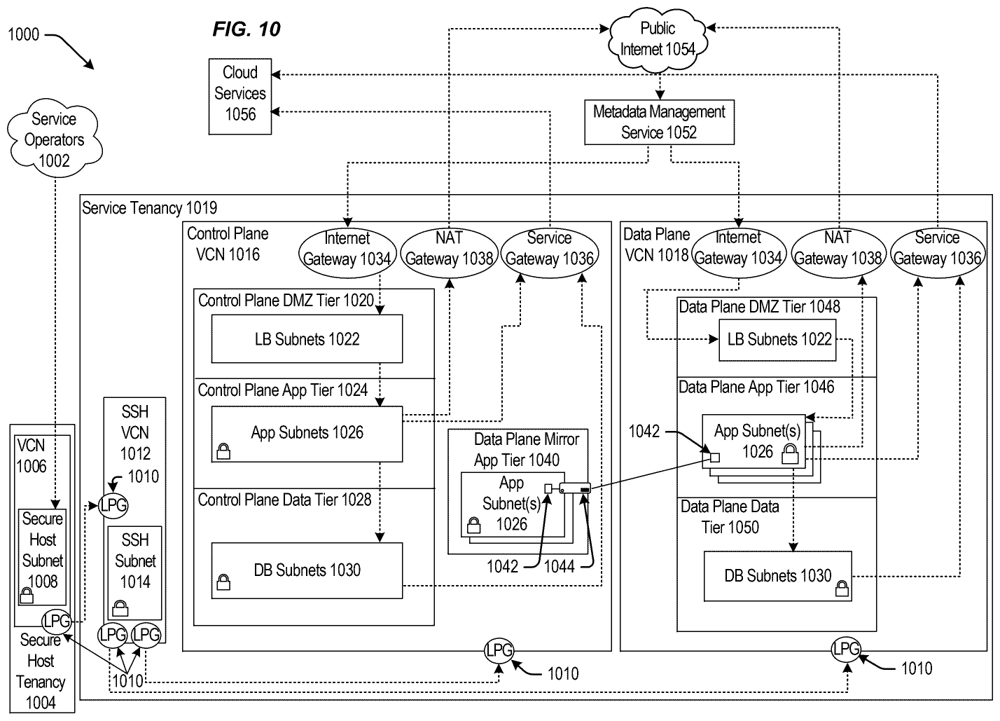

FIG. 10 is a block diagram 1000 illustrating an example pattern of an IaaS architecture, according to at least one embodiment. Service operators 1002 can be communicatively coupled to a secure host tenancy 1004 that can include a virtual cloud network (VCN) 1006 and a secure host subnet 1008. In some examples, the service operators 1002 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1006 and/or the Internet.

The VCN 1006 can include a local peering gateway (LPG) 1010 that can be communicatively coupled to a secure shell (SSH) VCN 1012 via an LPG 1010 contained in the SSH VCN 1012. The SSH VCN 1012 can include an SSH subnet 1014, and the SSH VCN 1012 can be communicatively coupled to a control plane VCN 1016 via the LPG 1010 contained in the control plane VCN 1016. Also, the SSH VCN 1012 can be communicatively coupled to a data plane VCN 1018 via an LPG 1010. The control plane VCN 1016 and the data plane VCN 1018 can be contained in a service tenancy 1019 that can be owned and/or operated by the IaaS provider.

The control plane VCN 1016 can include a control plane demilitarized zone (DMZ) tier 1020 that acts as a perimeter network (e.g., portions of a corporate network between the corporate intranet and external networks). The DMZ-based servers may have restricted responsibilities and help keep breaches contained. Additionally, the DMZ tier 1020 can include one or more load balancer (LB) subnet(s) 1022, a control plane app tier 1024 that can include app subnet(s) 1026, a control plane data tier 1028 that can include database (DB) subnet(s) 1030 (e.g., frontend DB subnet(s) and/or backend DB subnet(s)). The LB subnet(s) 1022 contained in the control plane DMZ tier 1020 can be communicatively coupled to the app subnet(s) 1026 contained in the control plane app tier 1024 and an Internet gateway 1034 that can be contained in the control plane VCN 1016, and the app subnet(s) 1026 can be communicatively coupled to the DB subnet(s) 1030 contained in the control plane data tier 1028 and a service gateway 1036 and a network address translation (NAT) gateway 1038. The control plane VCN 1016 can include the service gateway 1036 and the NAT gateway 1038.

The control plane VCN 1016 can include a data plane mirror app tier 1040 that can include app subnet(s) 1026. The app subnet(s) 1026 contained in the data plane mirror app tier 1040 can include a virtual network interface controller (VNIC) 1042 that can execute a compute instance 1044. The compute instance 1044 can communicatively couple the app subnet(s) 1026 of the data plane mirror app tier 1040 to app subnet(s) 1026 that can be contained in a data plane app tier 1046.

The data plane VCN 1018 can include the data plane app tier 1046, a data plane DMZ tier 1048, and a data plane data tier 1050. The data plane DMZ tier 1048 can include LB subnet(s) 1022 that can be communicatively coupled to the app subnet(s) 1026 of the data plane app tier 1046 and the Internet gateway 1034 of the data plane VCN 1018. The app subnet(s) 1026 can be communicatively coupled to the service gateway 1036 of the data plane VCN 1018 and the NAT gateway 1038 of the data plane VCN 1018. The data plane data tier 1050 can also include the DB subnet(s) 1030 that can be communicatively coupled to the app subnet(s) 1026 of the data plane app tier 1046.

The Internet gateway 1034 of the control plane VCN 1016 and of the data plane VCN 1018 can be communicatively coupled to a metadata management service 1052 that can be communicatively coupled to public Internet 1054. Public Internet 1054 can be communicatively coupled to the NAT gateway 1038 of the control plane VCN 1016 and of the data plane VCN 1018. The service gateway 1036 of the control plane VCN 1016 and of the data plane VCN 1018 can be communicatively coupled to cloud services 1056.

In some examples, the service gateway 1036 of the control plane VCN 1016 or of the data plane VCN 1018 can make application programming interface (API) calls to cloud services 1056 without going through public Internet 1054. The API calls to cloud services 1056 from the service gateway 1036 can be one-way: the service gateway 1036 can make API calls to cloud services 1056, and cloud services 1056 can send requested data to the service gateway 1036. But, cloud services 1056 may not initiate API calls to the service gateway 1036.

In some examples, the secure host tenancy 1004 can be directly connected to the service tenancy 1019, which may be otherwise isolated. The secure host subnet 1008 can communicate with the SSH subnet 1014 through an LPG 1010 that may enable two-way communication over an otherwise isolated system. Connecting the secure host subnet 1008 to the SSH subnet 1014 may give the secure host subnet 1008 access to other entities within the service tenancy 1019.

The control plane VCN 1016 may allow users of the service tenancy 1019 to set up or otherwise provision desired resources. Desired resources provisioned in the control plane VCN 1016 may be deployed or otherwise used in the data plane VCN 1018. In some examples, the control plane VCN 1016 can be isolated from the data plane VCN 1018, and the data plane mirror app tier 1040 of the control plane VCN 1016 can communicate with the data plane app tier 1046 of the data plane VCN 1018 via VNICs 1042 that can be contained in the data plane mirror app tier 1040 and the data plane app tier 1046.

In some examples, users of the system, or customers, can make requests, for example create, read, update, or delete (CRUD) operations, through public Internet 1054 that can communicate the requests to the metadata management service 1052. The metadata management service 1052 can communicate the request to the control plane VCN 1016 through the Internet gateway 1034. The request can be received by the LB subnet(s) 1022 contained in the control plane DMZ tier 1020. The LB subnet(s) 1022 may determine that the request is valid, and in response to this determination, the LB subnet(s) 1022 can transmit the request to app subnet(s) 1026 contained in the control plane app tier 1024. If the request is validated and requires a call to public Internet 1054, the call to public Internet 1054 may be transmitted to the NAT gateway 1038 that can make the call to public Internet 1054. Metadata that may be desired to be stored by the request can be stored in the DB subnet(s) 1030.

In some examples, the data plane mirror app tier 1040 can facilitate direct communication between the control plane VCN 1016 and the data plane VCN 1018. For example, changes, updates, or other suitable modifications to configuration may be desired to be applied to the resources contained in the data plane VCN 1018. Via a VNIC 1042, the control plane VCN 1016 can directly communicate with, and can thereby execute the changes, updates, or other suitable modifications to configuration to, resources contained in the data plane VCN 1018.

In some embodiments, the control plane VCN 1016 and the data plane VCN 1018 can be contained in the service tenancy 1019. In this case, the user, or the customer, of the system may not own or operate either the control plane VCN 1016 or the data plane VCN 1018. Instead, the IaaS provider may own or operate the control plane VCN 1016 and the data plane VCN 1018, both of which may be contained in the service tenancy 1019. This embodiment can enable isolation of networks that may prevent users or customers from interacting with other users', or other customers', resources. Also, this embodiment may allow users or customers of the system to store databases privately without needing to rely on public Internet 1054, which may not have a desired level of threat prevention, for storage.

In other embodiments, the LB subnet(s) 1022 contained in the control plane VCN 1016 can be configured to receive a signal from the service gateway 1036. In this embodiment, the control plane VCN 1016 and the data plane VCN 1018 may be configured to be called by a customer of the IaaS provider without calling public Internet 1054. Customers of the IaaS provider may desire this embodiment since database(s) that the customers use may be controlled by the IaaS provider and may be stored on the service tenancy 1019, which may be isolated from public Internet 1054.

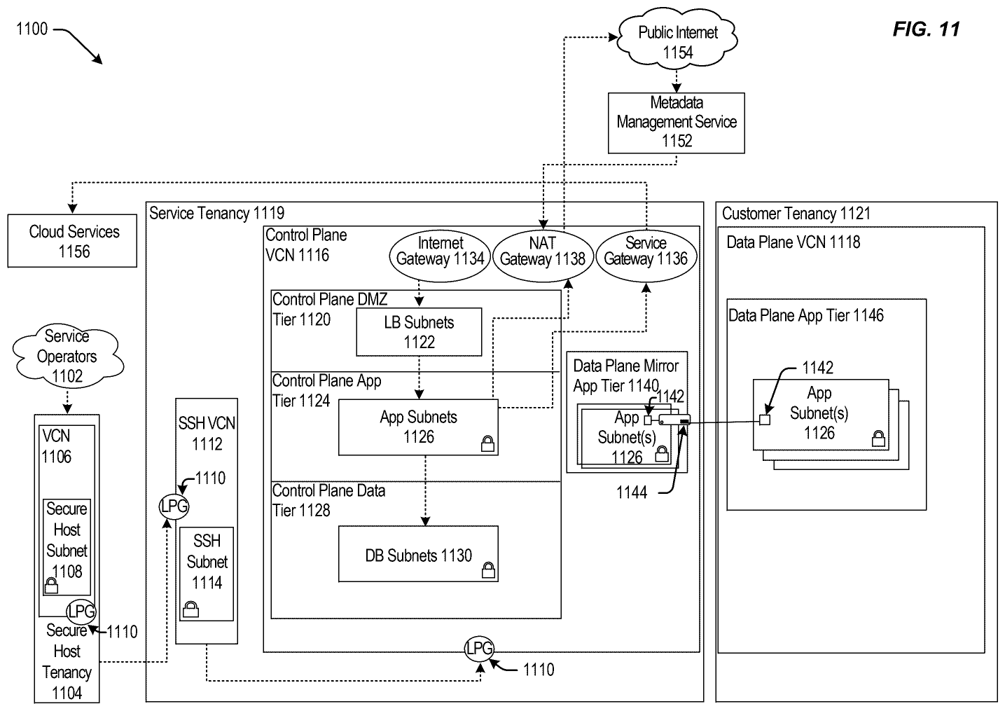

FIG. 11 is a block diagram 1100 illustrating another example pattern of an IaaS architecture, according to at least one embodiment. Service operators 1102 (e.g., service operators 1002 of FIG. 10) can be communicatively coupled to a secure host tenancy 1104 (e.g., the secure host tenancy 1004 of FIG. 10) that can include a virtual cloud network (VCN) 1106 (e.g., the VCN 1006 of FIG. 10) and a secure host subnet 1108 (e.g., the secure host subnet 1008 of FIG. 10). The VCN 1106 can include a local peering gateway (LPG) 1110 (e.g., the LPG 1010 of FIG. 10) that can be communicatively coupled to a secure shell (SSH) VCN 1112 (e.g., the SSH VCN 1012 of FIG. 10) via an LPG 1010 contained in the SSH VCN 1112. The SSH VCN 1112 can include an SSH subnet 1114 (e.g., the SSH subnet 1014 of FIG. 10), and the SSH VCN 1112 can be communicatively coupled to a control plane VCN 1116 (e.g., the control plane VCN 1016 of FIG. 10) via an LPG 1110 contained in the control plane VCN 1116. The control plane VCN 1116 can be contained in a service tenancy 1119 (e.g., the service tenancy 1019 of FIG. 10), and the data plane VCN 1118 (e.g., the data plane VCN 1018 of FIG. 10) can be contained in a customer tenancy 1121 that may be owned or operated by users, or customers, of the system.

The control plane VCN 1116 can include a control plane DMZ tier 1120 (e.g., the control plane DMZ tier 1020 of FIG. 10) that can include LB subnet(s) 1122 (e.g., LB subnet(s) 1022 of FIG. 10), a control plane app tier 1124 (e.g., the control plane app tier 1024 of FIG. 10) that can include app subnet(s) 1126 (e.g., app subnet(s) 1026 of FIG. 10), a control plane data tier 1128 (e.g., the control plane data tier 1028 of FIG. 10) that can include database (DB) subnet(s) 1130 (e.g., similar to DB subnet(s) 1030 of FIG. 10). The LB subnet(s) 1122 contained in the control plane DMZ tier 1120 can be communicatively coupled to the app subnet(s) 1126 contained in the control plane app tier 1124 and an Internet gateway 1134 (e.g., the Internet gateway 1034 of FIG. 10) that can be contained in the control plane VCN 1116, and the app subnet(s) 1126 can be communicatively coupled to the DB subnet(s) 1130 contained in the control plane data tier 1128 and a service gateway 1136 (e.g., the service gateway 1036 of FIG. 10) and a network address translation (NAT) gateway 1138 (e.g., the NAT gateway 1038 of FIG. 10). The control plane VCN 1116 can include the service gateway 1136 and the NAT gateway 1138.

The control plane VCN 1116 can include a data plane mirror app tier 1140 (e.g., the data plane mirror app tier 1040 of FIG. 10) that can include app subnet(s) 1126. The app subnet(s) 1126 contained in the data plane mirror app tier 1140 can include a virtual network interface controller (VNIC) 1142 (e.g., the VNIC of 1042) that can execute a compute instance 1144 (e.g., similar to the compute instance 1044 of FIG. 10). The compute instance 1144 can facilitate communication between the app subnet(s) 1126 of the data plane mirror app tier 1140 and the app subnet(s) 1126 that can be contained in a data plane app tier 1146 (e.g., the data plane app tier 1046 of FIG. 10) via the VNIC 1142 contained in the data plane mirror app tier 1140 and the VNIC 1142 contained in the data plane app tier 1146.

The Internet gateway 1134 contained in the control plane VCN 1116 can be communicatively coupled to a metadata management service 1152 (e.g., the metadata management service 1052 of FIG. 10) that can be communicatively coupled to public Internet 1154 (e.g., public Internet 1054 of FIG. 10). Public Internet 1154 can be communicatively coupled to the NAT gateway 1138 contained in the control plane VCN 1116. The service gateway 1136 contained in the control plane VCN 1116 can be communicatively coupled to cloud services 1156 (e.g., cloud services 1056 of FIG. 10).

In some examples, the data plane VCN 1118 can be contained in the customer tenancy 1121. In this case, the IaaS provider may provide the control plane VCN 1116 for each customer, and the IaaS provider may, for each customer, set up a unique compute instance 1144 that is contained in the service tenancy 1119. Each compute instance 1144 may allow communication between the control plane VCN 1116, contained in the service tenancy 1119, and the data plane VCN 1118 that is contained in the customer tenancy 1121. The compute instance 1144 may allow resources, that are provisioned in the control plane VCN 1116 that is contained in the service tenancy 1119, to be deployed or otherwise used in the data plane VCN 1118 that is contained in the customer tenancy 1121.

In other examples, the customer of the IaaS provider may have databases that live in the customer tenancy 1121. In this example, the control plane VCN 1116 can include the data plane mirror app tier 1140 that can include app subnet(s) 1126. The data plane mirror app tier 1140 can reside in the data plane VCN 1118, but the data plane mirror app tier 1140 may not live in the data plane VCN 1118. That is, the data plane mirror app tier 1140 may have access to the customer tenancy 1121, but the data plane mirror app tier 1140 may not exist in the data plane VCN 1118 or be owned or operated by the customer of the IaaS provider. The data plane mirror app tier 1140 may be configured to make calls to the data plane VCN 1118 but may not be configured to make calls to any entity contained in the control plane VCN 1116. The customer may desire to deploy or otherwise use resources in the data plane VCN 1118 that are provisioned in the control plane VCN 1116, and the data plane mirror app tier 1140 can facilitate the desired deployment, or other usage of resources, of the customer.

In some embodiments, the customer of the IaaS provider can apply filters to the data plane VCN 1118. In this embodiment, the customer can determine what the data plane VCN 1118 can access, and the customer may restrict access to public Internet 1154 from the data plane VCN 1118. The IaaS provider may not be able to apply filters or otherwise control access of the data plane VCN 1118 to any outside networks or databases. Applying filters and controls by the customer onto the data plane VCN 1118, contained in the customer tenancy 1121, can help isolate the data plane VCN 1118 from other customers and from public Internet 1154.

In some embodiments, cloud services 1156 can be called by the service gateway 1136 to access services that may not exist on public Internet 1154, on the control plane VCN 1116, or on the data plane VCN 1118. The connection between cloud services 1156 and the control plane VCN 1116 or the data plane VCN 1118 may not be live or continuous. Cloud services 1156 may exist on a different network owned or operated by the IaaS provider. Cloud services 1156 may be configured to receive calls from the service gateway 1136 and may be configured to not receive calls from public Internet 1154. Some cloud services 1156 may be isolated from other cloud services 1156, and the control plane VCN 1116 may be isolated from cloud services 1156 that may not be in the same region as the control plane VCN 1116. For example, the control plane VCN 1116 may be located in “Region 1,” and cloud service “Deployment 10,” may be located in Region 1 and in “Region 2.” If a call to Deployment 10 is made by the service gateway 1136 contained in the control plane VCN 1116 located in Region 1, the call may be transmitted to Deployment 10 in Region 1. In this example, the control plane VCN 1116, or Deployment 10 in Region 1, may not be communicatively coupled to, or otherwise in communication with, Deployment 10 in Region 2.

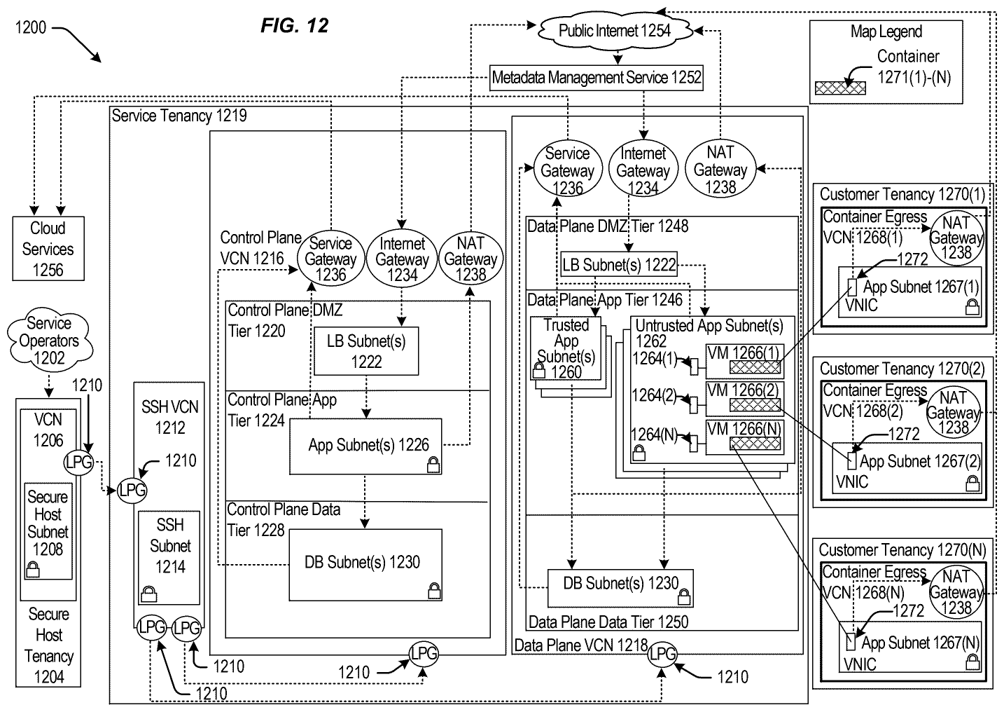

FIG. 12 is a block diagram 1200 illustrating another example pattern of an IaaS architecture, according to at least one embodiment. Service operators 1202 (e.g., service operators 1002 of FIG. 10) can be communicatively coupled to a secure host tenancy 1204 (e.g., the secure host tenancy 1004 of FIG. 10) that can include a virtual cloud network (VCN) 1206 (e.g., the VCN 1006 of FIG. 10) and a secure host subnet 1208 (e.g., the secure host subnet 1008 of FIG. 10). The VCN 1206 can include an LPG 1210 (e.g., the LPG 1010 of FIG. 10) that can be communicatively coupled to an SSH VCN 1212 (e.g., the SSH VCN 1012 of FIG. 10) via an LPG 1210 contained in the SSH VCN 1212. The SSH VCN 1212 can include an SSH subnet 1214 (e.g., the SSH subnet 1014 of FIG. 10), and the SSH VCN 1212 can be communicatively coupled to a control plane VCN 1216 (e.g., the control plane VCN 1016 of FIG. 10) via an LPG 1210 contained in the control plane VCN 1216 and to a data plane VCN 1218 (e.g., the data plane 1018 of FIG. 10) via an LPG 1210 contained in the data plane VCN 1218. The control plane VCN 1216 and the data plane VCN 1218 can be contained in a service tenancy 1219 (e.g., the service tenancy 1019 of FIG. 10).

The control plane VCN 1216 can include a control plane DMZ tier 1220 (e.g., the control plane DMZ tier 1020 of FIG. 10) that can include load balancer (LB) subnet(s) 1222 (e.g., LB subnet(s) 1022 of FIG. 10), a control plane app tier 1224 (e.g., the control plane app tier 1024 of FIG. 10) that can include app subnet(s) 1226 (e.g., similar to app subnet(s) 1026 of FIG. 10), a control plane data tier 1228 (e.g., the control plane data tier 1028 of FIG. 10) that can include DB subnet(s) 1230. The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 1034 of FIG. 10) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 10) and a network address translation (NAT) gateway 1238 (e.g., the NAT gateway 1038 of FIG. 10). The control plane VCN 1216 can include the service gateway 1236 and the NAT gateway 1238.

The data plane VCN 1218 can include a data plane app tier 1246 (e.g., the data plane app tier 1046 of FIG. 10), a data plane DMZ tier 1248 (e.g., the data plane DMZ tier 1048 of FIG. 10), and a data plane data tier 1250 (e.g., the data plane data tier 1050 of FIG. 10). The data plane DMZ tier 1248 can include LB subnet(s) 1222 that can be communicatively coupled to trusted app subnet(s) 1260 and untrusted app subnet(s) 1262 of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include one or more primary VNICs 1264(1)-(N) that can be communicatively coupled to tenant virtual machines (VMs) 1266(1)-(N). Each tenant VM 1266(1)-(N) can be communicatively coupled to a respective app subnet 1267(1)-(N) that can be contained in respective container egress VCNs 1268(1)-(N) that can be contained in respective customer tenancies 1270(1)-(N). Respective secondary VNICs 1272(1)-(N) can facilitate communication between the untrusted app subnet(s) 1262 contained in the data plane VCN 1218 and the app subnet contained in the container egress VCNs 1268(1)-(N). Each container egress VCNs 1268(1)-(N) can include a NAT gateway 1238 that can be communicatively coupled to public Internet 1254 (e.g., public Internet 1054 of FIG. 10).

The Internet gateway 1234 contained in the control plane VCN 1216 and contained in the data plane VCN 1218 can be communicatively coupled to a metadata management service 1252 (e.g., the metadata management system 1052 of FIG. 10) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some embodiments, the data plane VCN 1218 can be integrated with customer tenancies 1270. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1246. Code to run the function may be executed in the VMs 1266(1)-(N), and the code may not be configured to run anywhere else on the data plane VCN 1218. Each VM 1266(1)-(N) may be connected to one customer tenancy 1270. Respective containers 1271(1)-(N) contained in the VMs 1266(1)-(N) may be configured to run the code. In this case, there can be a dual isolation (e.g., the containers 1271(1)-(N) running code, where the containers 1271(1)-(N) may be contained in at least the VM 1266(1)-(N) that are contained in the untrusted app subnet(s) 1262), which may help prevent incorrect or otherwise undesirable code from damaging the network of the IaaS provider or from damaging a network of a different customer. The containers 1271(1)-(N) may be communicatively coupled to the customer tenancy 1270 and may be configured to transmit or receive data from the customer tenancy 1270. The containers 1271(1)-(N) may not be configured to transmit or receive data from any other entity in the data plane VCN 1218. Upon completion of running the code, the IaaS provider may kill or otherwise dispose of the containers 1271(1)-(N).

In some embodiments, the trusted app subnet(s) 1260 may run code that may be owned or operated by the IaaS provider. In this embodiment, the trusted app subnet(s) 1260 may be communicatively coupled to the DB subnet(s) 1230 and be configured to execute CRUD operations in the DB subnet(s) 1230. The untrusted app subnet(s) 1262 may be communicatively coupled to the DB subnet(s) 1230, but in this embodiment, the untrusted app subnet(s) may be configured to execute read operations in the DB subnet(s) 1230. The containers 1271(1)-(N) that can be contained in the VM 1266(1)-(N) of each customer and that may run code from the customer may not be communicatively coupled with the DB subnet(s) 1230.

In other embodiments, the control plane VCN 1216 and the data plane VCN 1218 may not be directly communicatively coupled. In this embodiment, there may be no direct communication between the control plane VCN 1216 and the data plane VCN 1218. However, communication can occur indirectly through at least one method. An LPG 1210 may be established by the IaaS provider that can facilitate communication between the control plane VCN 1216 and the data plane VCN 1218. In another example, the control plane VCN 1216 or the data plane VCN 1218 can make a call to cloud services 1256 via the service gateway 1236. For example, a call to cloud services 1256 from the control plane VCN 1216 can include a request for a service that can communicate with the data plane VCN 1218.

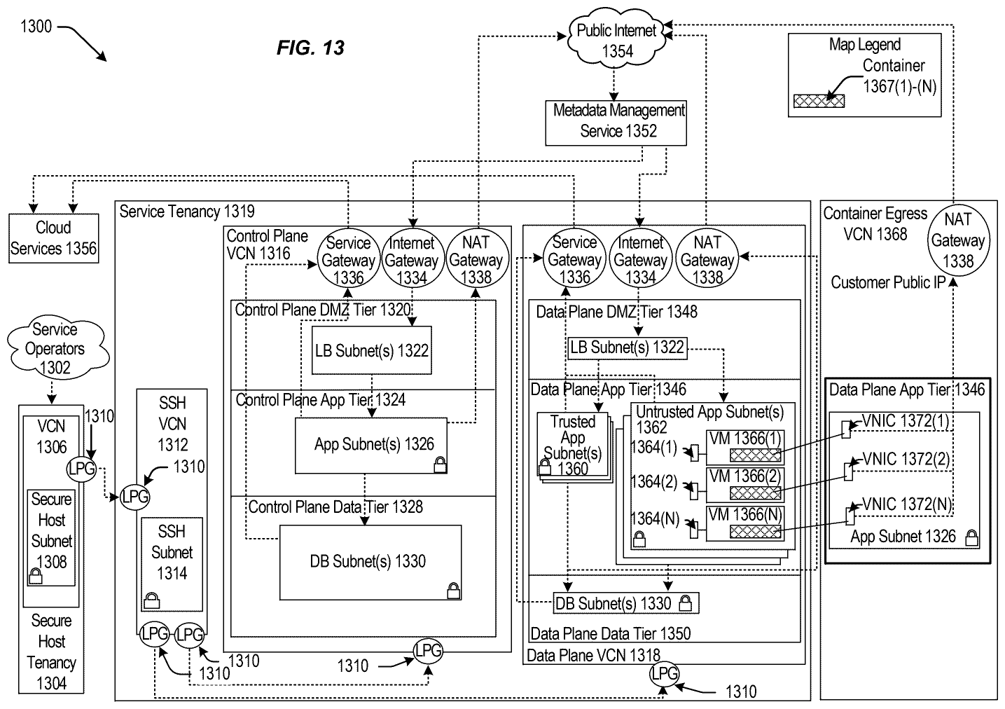

FIG. 13 is a block diagram 1300 illustrating another example pattern of an IaaS architecture, according to at least one embodiment. Service operators 1302 (e.g., service operators 1002 of FIG. 10) can be communicatively coupled to a secure host tenancy 1304 (e.g., the secure host tenancy 1004 of FIG. 10) that can include a virtual cloud network (VCN) 1306 (e.g., the VCN 1006 of FIG. 10) and a secure host subnet 1308 (e.g., the secure host subnet 1008 of FIG. 10). The VCN 1306 can include an LPG 1310 (e.g., the LPG 1010 of FIG. 10) that can be communicatively coupled to an SSH VCN 1312 (e.g., the SSH VCN 1012 of FIG. 10) via an LPG 1310 contained in the SSH VCN 1312. The SSH VCN 1312 can include an SSH subnet 1314 (e.g., the SSH subnet 1014 of FIG. 10), and the SSH VCN 1312 can be communicatively coupled to a control plane VCN 1316 (e.g., the control plane VCN 1016 of FIG. 10) via an LPG 1310 contained in the control plane VCN 1316 and to a data plane VCN 1318 (e.g., the data plane 1018 of FIG. 10) via an LPG 1310 contained in the data plane VCN 1318. The control plane VCN 1316 and the data plane VCN 1318 can be contained in a service tenancy 1319 (e.g., the service tenancy 1019 of FIG. 10).

The control plane VCN 1316 can include a control plane DMZ tier 1320 (e.g., the control plane DMZ tier 1020 of FIG. 10) that can include LB subnet(s) 1322 (e.g., LB subnet(s) 1022 of FIG. 10), a control plane app tier 1324 (e.g., the control plane app tier 1024 of FIG. 10) that can include app subnet(s) 1326 (e.g., app subnet(s) 1026 of FIG. 10), a control plane data tier 1328 (e.g., the control plane data tier 1028 of FIG. 10) that can include DB subnet(s) 1330 (e.g., DB subnet(s) 1230 of FIG. 12). The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1034 of FIG. 10) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 10) and a network address translation (NAT) gateway 1338 (e.g., the NAT gateway 1038 of FIG. 10). The control plane VCN 1316 can include the service gateway 1336 and the NAT gateway 1338.

The data plane VCN 1318 can include a data plane app tier 1346 (e.g., the data plane app tier 1046 of FIG. 10), a data plane DMZ tier 1348 (e.g., the data plane DMZ tier 1048 of FIG. 10), and a data plane data tier 1350 (e.g., the data plane data tier 1050 of FIG. 10). The data plane DMZ tier 1348 can include LB subnet(s) 1322 that can be communicatively coupled to trusted app subnet(s) 1360 (e.g., trusted app subnet(s) 1260 of FIG. 12) and untrusted app subnet(s) 1362 (e.g., untrusted app subnet(s) 1262 of FIG. 12) of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include primary VNICs 1364(1)-(N) that can be communicatively coupled to tenant virtual machines (VMs) 1366(1)-(N) residing within the untrusted app subnet(s) 1362. Each tenant VM 1366(1)-(N) can run code in a respective container 1367(1)-(N), and be communicatively coupled to an app subnet 1326 that can be contained in a data plane app tier 1346 that can be contained in a container egress VCN 1368. Respective secondary VNICs 1372(1)-(N) can facilitate communication between the untrusted app subnet(s) 1362 contained in the data plane VCN 1318 and the app subnet contained in the container egress VCN 1368. The container egress VCN can include a NAT gateway 1338 that can be communicatively coupled to public Internet 1354 (e.g., public Internet 1054 of FIG. 10).

The Internet gateway 1334 contained in the control plane VCN 1316 and contained in the data plane VCN 1318 can be communicatively coupled to a metadata management service 1352 (e.g., the metadata management system 1052 of FIG. 10) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some examples, the pattern illustrated by the architecture of block diagram 1300 of FIG. 13 may be considered an exception to the pattern illustrated by the architecture of block diagram 1200 of FIG. 12 and may be desirable for a customer of the IaaS provider if the IaaS provider cannot directly communicate with the customer (e.g., a disconnected region). The respective containers 1367(1)-(N) that are contained in the VMs 1366(1)-(N) for each customer can be accessed in real-time by the customer. The containers 1367(1)-(N) may be configured to make calls to respective secondary VNICs 1372(1)-(N) contained in app subnet(s) 1326 of the data plane app tier 1346 that can be contained in the container egress VCN 1368. The secondary VNICs 1372(1)-(N) can transmit the calls to the NAT gateway 1338 that may transmit the calls to public Internet 1354. In this example, the containers 1367(1)-(N) that can be accessed in real-time by the customer can be isolated from the control plane VCN 1316 and can be isolated from other entities contained in the data plane VCN 1318. The containers 1367(1)-(N) may also be isolated from resources from other customers.

In other examples, the customer can use the containers 1367(1)-(N) to call cloud services 1356. In this example, the customer may run code in the containers 1367(1)-(N) that requests a service from cloud services 1356. The containers 1367(1)-(N) can transmit this request to the secondary VNICs 1372(1)-(N) that can transmit the request to the NAT gateway that can transmit the request to public Internet 1354. Public Internet 1354 can transmit the request to LB subnet(s) 1322 contained in the control plane VCN 1316 via the Internet gateway 1334. In response to determining the request is valid, the LB subnet(s) can transmit the request to app subnet(s) 1326 that can transmit the request to cloud services 1356 via the service gateway 1336.

It should be appreciated that IaaS architectures 1000, 1100, 1200, 1300 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

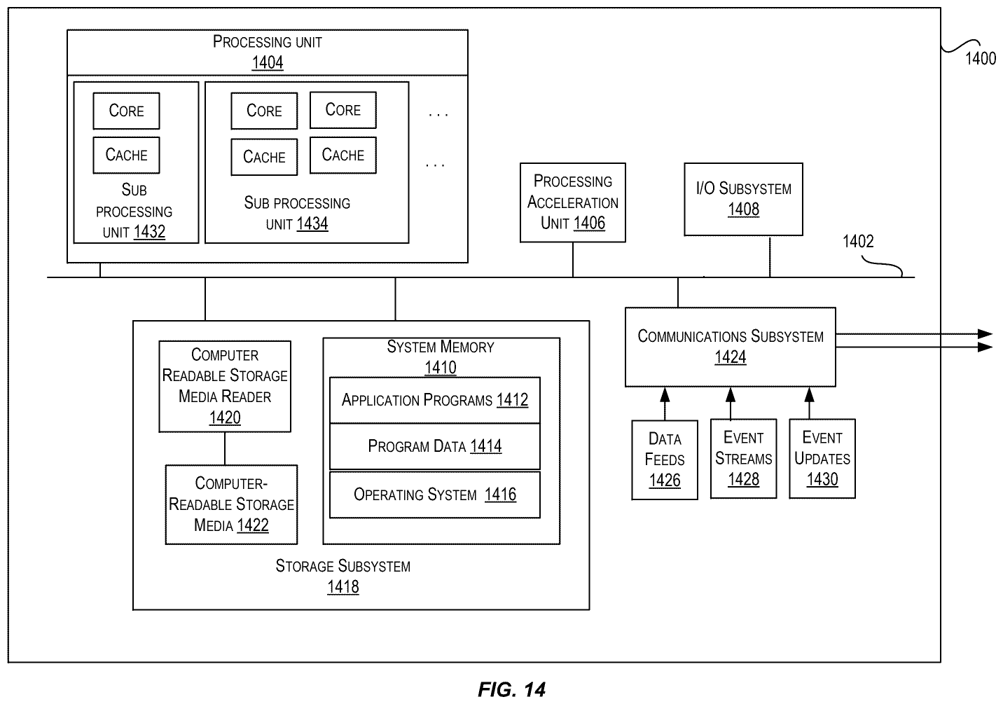

FIG. 14 illustrates an example computer system 1400, in which various embodiments may be implemented. The system 1400 may be used to implement any of the computer systems described above. As shown in the figure, computer system 1400 includes a processing unit 1404 that communicates with a number of peripheral subsystems via a bus subsystem 1402. These peripheral subsystems may include a processing acceleration unit 1406, an I/O subsystem 1408, a storage subsystem 1418 and a communications subsystem 1424. Storage subsystem 1418 includes tangible computer-readable storage media 1422 and a system memory 1410.

Bus subsystem 1402 provides a mechanism for letting the various components and subsystems of computer system 1400 communicate with each other as intended. Although bus subsystem 1402 is shown schematically as a single bus, alternative embodiments of the bus subsystem may utilize multiple buses. Bus subsystem 1402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1404, which can be implemented as one or more integrated circuits (e.g., a conventional microprocessor or microcontroller), controls the operation of computer system 1400. One or more processors may be included in processing unit 1404. These processors may include single core or multicore processors. In certain embodiments, processing unit 1404 may be implemented as one or more independent processing units 1432 and/or 1434 with single or multicore processors included in each processing unit. In other embodiments, processing unit 1404 may also be implemented as a quad-core processing unit formed by integrating two dual-core processors into a single chip.

In various embodiments, processing unit 1404 can execute a variety of programs in response to program code and can maintain multiple concurrently executing programs or processes. At any given time, some or all of the program code to be executed can be resident in processor(s) 1404 and/or in storage subsystem 1418. Through suitable programming, processor(s) 1404 can provide various functionalities described above. Computer system 1400 may additionally include a processing acceleration unit 1406, which can include a digital signal processor (DSP), a special-purpose processor, and/or the like.

I/O subsystem 1408 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1400 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1400 may comprise a storage subsystem 1418 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1404 provide the functionality described above. Storage subsystem 1418 may also provide a repository for storing data used in accordance with the present disclosure.

As depicted in the example in FIG. 14, storage subsystem 1418 can include various components including a system memory 1410, computer-readable storage media 1422, and a computer readable storage media reader 1420. System memory 1410 may store program instructions that are loadable and executable by processing unit 1404. System memory 1410 may also store data that is used during the execution of the instructions and/or data that is generated during the execution of the program instructions. Various different kinds of programs may be loaded into system memory 1410 including but not limited to client applications, Web browsers, mid-tier applications, relational database management systems (RDBMS), virtual machines, containers, etc.

System memory 1410 may also store an operating system 1416. Examples of operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1400 executes one or more virtual machines, the virtual machines along with their guest operating systems (GOSs) may be loaded into system memory 1410 and executed by one or more processors or cores of processing unit 1404.

System memory 1410 can come in different configurations depending upon the type of computer system 1400. For example, system memory 1410 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1410 may include a basic input/output system (BIOS) containing basic routines that help to transfer information between elements within computer system 1400, such as during start-up.

Computer-readable storage media 1422 may represent remote, local, fixed, and/or removable storage devices plus storage media for temporarily and/or more permanently containing, storing, computer-readable information for use by computer system 1400 including instructions executable by processing unit 1404 of computer system 1400.

Computer-readable storage media 1422 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1400.

Machine-readable instructions executable by one or more processors or cores of processing unit 1404 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some embodiments communications subsystem 1424 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1424 can provide wired network connectivity (e.g., Ethernet) in addition to or instead of a wireless interface.

In some embodiments, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive data feeds 1426 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1424 may also be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a computing system, a two-dimensional image comprising a first dimension, a second dimension, and one or more objects;
receiving, by the computing system, a range threshold for each sub-image, the range threshold comprising a lower boundary and an upper boundary of number of pixels;
partitioning, by the computing system, the first dimension of the image into a set of first-dimension (D1) segments, the length of each of the set of D1 segments being a different D1 random number and within the range threshold;
partitioning, by the computing system, the second dimension of the two-dimensional image into a set of second-dimension (D2) segments, the length of each of the set of D2 segments being a different D2 random number and within the range threshold;
creating, by the computing system, a set of sub-images from the images by combining the set of D1 segments and the set of D2 segments in one-to-one correspondence; and
re-arranging, by the computing system, the set of sub-images randomly in both the first dimension and the second dimension.

2. The method of claim 1, wherein partitioning the two-dimensional image further comprises:
setting a first segment of the set of D1 segments to be a first particular D1 length;
partitioning the first dimension using the remaining D1 segments, wherein each of the remaining D1 segments has a different D1 random number;
setting a second segment of the set of D2 segments to be a second particular D2 length; and
partitioning the second dimension using the remaining D2 segments, wherein each of the remaining D2 segments has a different D2 random number.

3. The method of claim 2, further comprising creating a first sub-image having a width of the first particular D1 length and a height of the second particular D2 length, wherein the first sub-image overlaps at least a first object of the one or more objects in the two-dimensional image.

4. The method of claim 1, further comprising merging two or more adjacent sub-images into a larger sub-image, wherein the larger sub-image has width and height each within the range threshold.

5. The method of claim 1, wherein re-arranging the set of sub-images further comprises:
determining the number of objects in the one or more objects in the two-dimensional image;
dividing the two-dimensional image into one or more regions;
identifying at least a first region that includes a greater number of objects than other regions; and
moving sub-images of the set of sub-images based at least in part on an arrangement configuration.

6. The method of claim 5, wherein:
the arrangement configuration is a higher probability of partitioning more objects, and
moving sub-images of the set of sub-images comprises moving smaller sub-images of the set of sub-images closer to the first region.

7. The method of claim 5, wherein:
the arrangement configuration is a higher probability of having one sub-image covering more objects, and
moving sub-images of the set of sub-images comprises moving larger sub-images of the set of sub-images closer to the first region.

8. The method of claim 1, further comprising editing a sub-image of the set of sub-image to change one or more characteristics of the two-dimensional image.

9. The method of claim 8, wherein the one or more characteristics of the two-dimensional image comprise memorability of the two-dimensional image.

10. A non-transitory computer-readable medium storing computer-executable instructions that, when executed by one or more processors of a computing system, cause the one or more processors to perform operations comprising:
receiving, by a computing system, a two-dimensional image comprising a first dimension and a second dimension, and one or more objects;
receiving, by the computing system, a range threshold for each sub-image, the range threshold comprising a lower boundary and an upper boundary of number of pixels;
partitioning, by the computing system, the first dimension of the image into a set of first-dimension (D1) segments, the length of each of the set of D1 segments being a different D1 random number and within the range threshold;
partitioning, by the computing system, the second dimension of the two-dimensional image into a set of second-dimension (D2) segments, the length of each of the set of D2 segments being a different D2 random number and within the range threshold;
creating, by the computing system, a set of sub-images from the images by combining the set of D1 segments and the set of D2 segments in one-to-one correspondence; and
re-arranging, by the computing system, the set of sub-images randomly in both the first dimension and the second dimension.

11. The non-transitory computer-readable medium of claim 10, wherein partitioning the two-dimensional image further comprises:
setting a first segment of the set of D1 segments to be a first particular D1 length;
partitioning the first dimension using the remaining D1 segments, wherein each of the remaining D1 segments has a different D1 random number;
setting a second segment of the set of D2 segments to be a second particular D2 length;
partitioning the second dimension using the remaining D2 segments, wherein each of the remaining D2 segments has a different D2 random number; and
creating a first sub-image having a width of the first particular D1 length and a height of the second particular D2 length, wherein the first sub-image overlaps at least a first object of the one or more objects in the two-dimensional image.

12. The non-transitory computer-readable medium of claim 10, further comprising merging two or more adjacent sub-images into a larger sub-image, wherein the larger sub-image has width and height each within the range threshold.

13. The non-transitory computer-readable medium of claim 10, wherein re-arranging the set of sub-images further comprises:
determining the number of objects in the one or more objects in the two-dimensional image;
dividing the two-dimensional image into one or more regions;
identifying at least a first region that includes a greater number of objects than other regions; and
moving sub-images of the set of sub-images based at least in part on an arrangement configuration.

14. The non-transitory computer-readable medium of claim 13, wherein:
the arrangement configuration is a higher probability of partitioning more objects, and
moving sub-images of the set of sub-images comprises moving smaller sub-images of the set of sub-images closer to the first region.

15. The non-transitory computer-readable medium of claim 13, wherein:
the arrangement configuration is a higher probability of having one sub-image covering more objects, and
moving sub-images of the set of sub-images comprises moving larger sub-images of the set of sub-images closer to the first region.

16. The non-transitory computer-readable medium of claim 10, further comprising editing a sub-image of the set of sub-image to change one or more characteristics of the two-dimensional image;
wherein the one or more characteristics of the two-dimensional image comprise memorability of the two-dimensional image.

17. A computing system, comprising:
one or more processors; and
one or more non-transitory computer readable media storing computer-executable instructions that, when executed by the one or more processors of the computing system, cause the computing system to:
receive, by the computing system, a two-dimensional image comprising a first dimension and a second dimension, and one or more objects;
receive, by the computing system, a range threshold for each sub-image, the range threshold comprising a lower boundary and an upper boundary of number of pixels;
partition, by the computing system, the first dimension of the image into a set of first-dimension (D1) segments, the length of each of the set of D1 segments being a different D1 random number and within the range threshold;
partition, by the computing system, the second dimension of the two-dimensional image into a set of second-dimension (D2) segments, the length of each of the set of D2 segments being a different D2 random number and within the range threshold;
create, by the computing system, a set of sub-images from the images by combining the set of D1 segments and the set of D2 segments in one-to-one correspondence; and
re-arrange, by the computing system, the set of sub-images randomly in both the first dimension and the second dimension.

18. The computing system of claim 17, wherein partitioning the two-dimensional image further comprises:
setting a first segment of the set of D1 segments to be a first particular D1 length;
partitioning the first dimension using the remaining D1 segments, wherein each of the remaining D1 segments has a different D1 random number;
setting a second segment of the set of D2 segments to be a second particular D2 length;
partitioning the second dimension using the remaining D2 segments, wherein each of the remaining D2 segments has a different D2 random number; and
creating a first sub-image having a width of the first particular D1 length and a height of the second particular D2 length, wherein the first sub-image overlaps at least a first object of the one or more objects in the two-dimensional image.

19. The computing system of claim 17, wherein re-arranging the set of sub-images further comprises:
determining the number of objects in the one or more objects in the two-dimensional image;
dividing the two-dimensional image into one or more regions;
identifying at least a first region that includes a greater number of objects than other regions; and
moving sub-images of the set of sub-images based at least in part on an arrangement configuration;
wherein the arrangement configuration is a higher probability of partitioning more objects or a higher probability of having one sub-image covering more objects.

20. The computing system of claim 17, wherein the system is further caused to:
edit a sub-image of the set of sub-image to change one or more characteristics of the two-dimensional image;
wherein the one or more characteristics of the two-dimensional image comprise memorability of the two-dimensional image.
